(19) United States
(12) Patent Application Publication
(10) Pub. No.: US 2026/0037593 A1
(43) Pub. Date: Feb. 5, 2026

(54) Machine Learning Using Four-Bit Binary Data Formats

(71) Applicant: DeepMind Technologies Limited, London (GB)

(72) Inventors: Jian Li, Mountain View, CA (US); Sanjiv Kumar, Jericho, NY (US); Felix Chern, New York, NY (US); Zhifeng Chen, Sunnyvale, CA (US)

(21) Appl. No.: 18/793,328

(22) Filed: Aug. 2, 2024

(51) Int. Cl. G06F 17/15; G06F 7/22

(52) U.S. Cl. CPC G06F 17/15; G06F 7/22

(57) ABSTRACT

A computing system can obtain a machine-learned model comprising one or more parameters having a four-bit binary format. The four-bit binary format can correlate a plurality of sixteen respective binary values to a plurality of sixteen corresponding numerical values represented by the binary values. The sixteen numerical values can be symmetric about a median. A plurality of step sizes between the sixteen numerical values can be non-uniform. The computing system can obtain one or more input values for one or more layers of the machine-learned model. The computing system can process, based at least in part on the one or more parameters having the four-bit binary format, the one or more input values to generate one or more output values.

### FIELD

The present disclosure relates generally to machine learning processes and machine-learned devices and systems. More particularly, the present disclosure relates to machine learning using four-bit binary data formats for representing numerical values.

### BACKGROUND

A computing device can operate on binary data. The smallest unit of binary data is a “bit,” which can be represented as a single binary digit that can take the value 0 or 1. A binary data format is a format for representing various kinds of data items using one or more bits. For example, a 64-bit floating-point data format can represent numerical values between about 2.2*10⁻³⁰⁸ and about 1.8*10³⁰⁸ using 64 bits of binary data per number represented. As another example, a Unicode Transformation Format 8 (UTF-8) binary data format can represent text using between 8 and 32 bits per character represented.

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system comprising one or more computing devices, a machine-learned model comprising one or more parameters having a four-bit binary format. In the example method, the four-bit binary format can correlate sixteen respective binary values to sixteen corresponding numerical values represented by the binary values. In the example method, the sixteen numerical values can be symmetric about a median. In the example method, a plurality of step sizes between the sixteen numerical values can be non-uniform. The example method can include obtaining, by the computing system, one or more input values for one or more layers of the machine-learned model. The example method can include processing, by the computing system based at least in part on the one or more parameters having the four-bit binary format, the one or more input values to generate one or more output values.

In the example method, a difference between a first value and second value of the sixteen numerical values can be larger than a difference between a third value and a fourth value of the sixteen numerical values. In the example method, each of the third and fourth values can be closer to the median than each of the first and second values.

In the example method, the sixteen numerical values can consist of: [−7, −6, −5, −4, −3, −2, −1, −0.25, 0.25, 1, 2, 3, 4, 5, 6, 7].

In the example method, at least one of the one or more input values can have the four-bit binary format.

In the example method, at least one of the one or more output values can have the four-bit binary format.

In the example method, the machine-learned model can be a first machine-learned model. In the example method, obtaining the first machine-learned model can include obtaining a second machine-learned model having one or more parameters having a binary format requiring more than four bits to represent each numerical value. In the example method, obtaining the first machine-learned model can include quantizing the one or more parameters of the second machine-learned model to determine the one or more parameters of the first machine-learned model.

In the example method, the second machine-learned model can be a model that was trained by, for each of a plurality of iterations: obtaining, by the computing system, one or more training input values; transforming, by the computing system based at least in part on the sixteen numerical values, the one or more parameters of the second machine-learned model to generate transformed parameters; generating, by the computing system based at least in part on the transformed parameters, one or more machine-learned output values based on the one or more training input values; and updating, by the computing system based on the one or more machine-learned output values, the second machine-learned model.

In the example method, the second machine-learned model can include one or more adapter layers. In the example method, updating the second machine-learned model can include updating the one or more adapter layers.

The example method can include training the machine-learned model by, for each of a plurality of iterations: obtaining, by the computing system, one or more training input values; generating, by the computing system based at least in part on the one or more parameters having the four-bit binary format, one or more machine-learned output values based on the training input values; and updating, by the computing system based at least in part on the one or more output values, the machine-learned model.

In the example method, the machine-learned model can include one or more adapter layers. In the example method, updating the machine-learned model can include updating the one or more adapter layers.

In the example method, a ratio of each step size of the sixteen numerical values to a difference between a highest value and lowest value of the sixteen numerical values can be within 30 percent of:

$$[ \frac{1}{14} , \frac{1}{14} , \frac{1}{14} , \frac{1}{14} , \frac{1}{14} , \frac{1}{14} , \frac{3}{56} , \frac{2}{56} , \frac{3}{56} , \frac{1}{14} , \frac{1}{14} , \frac{1}{14} , \frac{1}{14} , \frac{1}{14} , \frac{1}{14} ] .$$

In the example method, generating the one or more output values can include mapping, by the computing system based on the binary format, the one or more parameters to one or more corresponding numerical parameter values. In the example method, generating the one or more output values can include performing, by the computing system using the numerical parameter values, a forward pass of the machine-learned model.

In the example method, the mapping can include scaling, by the computing system based on a first scaling factor associated with a first channel of a tensor comprising a plurality of parameters of the machine-learned model, a first plurality of numerical parameter values associated with the first channel. In the example method, the mapping can include scaling, by the computing system based on a second scaling factor associated with a second channel of the tensor, a second plurality of numerical parameter values associated with the second channel.

In the example method, the mapping can include offsetting, by the computing system based on a first offset value associated with the first channel, the first plurality of numerical parameter values. In the example method, the mapping can include offsetting, by the computing system based on a second offset value associated with the second channel, the second plurality of numerical parameter values.

In the example method, the one or more corresponding numerical parameter values can be represented in a binary format having more than four bits.

In the example method, the mapping can include retrieving, from one or more registers based at least in part on the one or more input values having the four-bit binary format, the one or more numerical parameter values.

In the example method, a difference between an eighth highest value and ninth highest value of the sixteen numerical values can be within 10 percent of 2/56 of a difference between a highest value and lowest value of the sixteen numerical values.

In the example method, a difference between a seventh highest value and an eighth highest value of the sixteen numerical values can be within 10 percent of 3/56 of a difference between a highest value and lowest value of the sixteen numerical values. In the example method, a difference between a ninth highest value and a tenth highest value of the sixteen numerical values can be within 10 percent of 3/56 of a difference between a highest value and lowest value of the sixteen numerical values.

In the example method, the sixteen numerical values can include sixteen non-zero numerical values.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining a machine-learned model comprising one or more parameters having a four-bit binary format. In the example computing system, the four-bit binary format can correlate sixteen respective binary values to sixteen corresponding numerical values represented by the binary values. In the example computing system, the sixteen numerical values can be symmetric about a median. In the example computing system, a plurality of step sizes between the sixteen numerical values can be non-uniform. The example operations can include obtaining one or more input values for one or more layers of the machine-learned model. The example operations can include processing, based at least in part on the one or more parameters having the four-bit binary format, the one or more input values to generate one or more output values.

The example computing system can include one or more registers storing one or more numerical values of the sixteen numerical values. In the example computing system, the operations can include retrieving, from the one or more registers based on a first binary representation of the sixteen respective binary values, a corresponding first numerical value of the sixteen numerical values.

The example computing system can include one or more multipliers configured to generate, based on the first numerical value and a second numerical value, a multiplication output.

The example computing system can include one or more matrix multiplication units configured to perform matrix multiplications based on input values associated with the four-bit binary format.

Example aspects of the present disclosure provide one or more example non-transitory computer-readable media storing instructions that are executable by one or more processors to cause a computing system to perform example operations. In some implementations, the example operations can include obtaining a machine-learned model comprising one or more parameters having a four-bit binary format. In some implementations, the four-bit binary format can correlate sixteen respective binary values to sixteen corresponding numerical values represented by the binary values. In some implementations, the sixteen numerical values can be symmetric about a median. In some implementations, a plurality of step sizes between the sixteen numerical values can be non-uniform. The example operations can include obtaining one or more input values for one or more layers of the machine-learned model. The example operations can include processing, based at least in part on the one or more parameters having the four-bit binary format, the one or more input values to generate one or more output values.

Example aspects of the present disclosure provide an example processor device. In some implementations, the example processor device can include one or more registers storing one or more numerical values associated with a four-bit binary format. In some implementations, the four-bit binary format can correlate sixteen respective binary values to sixteen corresponding numerical values represented by the binary values. In some implementations, the sixteen numerical values can be symmetric about a median. In some implementations, a plurality of step sizes between the sixteen numerical values can be non-uniform. The example processor device can include one or more programmable logic devices configured to retrieve, from the one or more registers based on a first binary value of the sixteen respective binary values, a corresponding first numerical value of the sixteen corresponding numerical values. The example processor device can include arithmetic hardware configured to perform operations based at least in part on the first numerical value.

In the example processor device, the arithmetic hardware can include one or more multipliers.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram illustrating an example four-bit binary data format according to example implementations of aspects of the present disclosure;

FIG. 2 is a block diagram illustrating an example four-bit binary data format according to example implementations of aspects of the present disclosure;

FIG. 3 is a block diagram of an example computing system for performing operations using a four-bit binary data format according to example implementations of aspects of the present disclosure;

FIG. 4 is a block diagram of an example system for quantizing a machine learning model according to example implementations of aspects of the present disclosure;

FIG. 5 is a block diagram of an example system for training a quantized machine learning model according to example implementations of aspects of the present disclosure;

FIG. 6 is a block diagram of an example computing system for performing operations using a four-bit binary data format according to example implementations of aspects of the present disclosure;

FIG. 7 is a flowchart diagram of an example method for performing operations using a four-bit binary data format according to example implementations of aspects of the present disclosure;

FIG. 8 is a flowchart diagram of an example method for training a machine-learned model using a four-bit binary data format according to example implementations of aspects of the present disclosure;

FIG. 9 is a flow chart diagram illustrating an example method for training a machine-learned model according to example implementations of aspects of the present disclosure;

FIG. 10 is a block diagram of an example processing flow for using machine-learned model(s) to process input(s) to generate output(s) according to example implementations of aspects of the present disclosure;

FIG. 11 is a block diagram of an example sequence processing model according to example implementations of aspects of the present disclosure;

FIG. 12 is a block diagram of an example technique for populating an example input sequence for processing by a sequence processing model according to example implementations of aspects of the present disclosure;

FIG. 13 is a block diagram of an example model development platform according to example implementations of aspects of the present disclosure;

FIG. 14 is a block diagram of an example training workflow for training a machine-learned model according to example implementations of aspects of the present disclosure;

FIG. 15 is a block diagram of an inference system for operating one or more machine-learned model(s) to perform inference according to example implementations of aspects of the present disclosure;

FIG. 16 is a block diagram of an example networked computing system according to example implementations of aspects of the present disclosure;

FIG. 17 is a block diagram of an example computing device according to example implementations of aspects of the present disclosure; and

FIG. 18 is a block diagram of an example computing device according to example implementations of aspects of the present disclosure.

### DETAILED DESCRIPTION

Generally, the present disclosure is directed to machine learning using four-bit binary data formats for representing numerical values. An example four-bit binary format can correlate sixteen possible binary values of four binary bits to sixteen distinct finite numerical values represented by the binary values. For example, in contrast to some alternative binary formats that may have binary representations for such values as infinity, negative infinity, not-a-number (NaN), or negative zero, example four-bit binary formats according to some aspects of the present disclosure can lack any “special” representations that do not represent a distinct numerical value.

In some instances, a four-bit binary format can have one or more properties that are similar to (e.g., same as, etc.) one or more properties of a mapping from the sixteen binary values to the following sixteen numerical values: {−7.0, −6.0, −5.0, −4.0, −3.0, −2.0, −1.0, −0.25, 0.25, 1.0, 2.0, 3.0, 4.0, 5.0, 6.0, 7.0}. For example, an example four-bit binary format can map to sixteen numerical values that are approximately symmetrical about a median (e.g., zero, etc.); approximately evenly spaced near the “ends” of a range of mapped values (i.e., at the highest n and lowest n numbers in the range, where n is an integer) with smaller spacing near the “middle” of the range of mapped values (e.g., at the 16-2n numbers nearest a median of the range); or otherwise arranged in a manner that is proportionally similar to the mapping of the example values listed above.

Example four-bit binary formats can be used in various computing operations. Example computing operations using four-bit binary formats can include various machine learning operations (e.g., quantized machine learning operations). For example, in some instances, machine-learned inference operations can be performed using example four-bit binary formats according to some aspects of the present disclosure. In some instances, machine learning training operations can be performed using example four-bit binary formats according to some aspects of the present disclosure.

In some instances, a four-bit binary representation can be used in quantized machine learning operations (e.g., using quantized sequence processing models, etc.). For example, a four-bit binary representation can be used for inference using a quantized machine-learned model. As another example, a four-bit binary representation can be used for training a quantized machine-learned model (e.g., using quantization-aware training, post-training quantization, quantized or partially quantized training, adapter-based fine-tuning methods, etc.) or other machine-learned model having one or more numerical parameters represented in a four-bit binary format.

In some instances, quantized operations can include scaling, rounding, clipping, offsetting, or otherwise transforming unquantized values (e.g., machine-learned model parameter values) to generate corresponding quantized values that can be represented using a four-bit binary format. For example, in some instances, quantizing a machine-learned model can include determining a minimum unquantized value min and maximum unquantized value max (e.g., absolute minimum or maximum, clipped minimum or maximum, etc.) to be represented by a four-bit binary format and correlating the sixteen binary representations to corresponding unquantized values based on the minimum and maximum. For example, in some instances, the sixteen corresponding unquantized values can be configured to be spaced between a minimum and maximum value according to a spacing that is proportionally similar to a spacing of the sixteen numbers {−7.0, −6.0, −5.0, −4.0, −3.0, −2.0, −1.0, −0.25, 0.25, 1.0, 2.0, 3.0, 4.0, 5.0, 6.0, 7.0}. For example, in some instances, sixteen four-bit binary representations can be mapped to sixteen corresponding unquantized values that are about equal to

$$\{ min , ( min + \frac{max - min}{14} ) , ( min + 2 \frac{max - min}{14} ) , ( min + 3 \frac{max - min}{14} ) , ( min + 4 \frac{max - min}{14} ) , ( min + 5 \frac{max - min}{14} ) , ( min + 6 \frac{max - min}{14} ) , ( min + 27 \frac{max - min}{56} ) , ( min + 29 \frac{max - min}{56} ) , ( min + 8 \frac{max - min}{14} ) , ( min + 9 \frac{max - min}{14} ) , ( min + 10 \frac{max - min}{14} ) , ( min + 11 \frac{max - min}{14} ) , ( min + 12 \frac{max - min}{14} ) , ( min + 13 \frac{max - min}{14} ) , max \} .$$

In some instances, a minimum and maximum value can be selected on a per-machine-learned-model basis; on a per-layer basis; on a per-tensor basis; on a per-channel basis; or the like. For example, in some instances, per-channel quantization can include determining a different minimum and maximum value for each channel of a plurality of channels (e.g., columns of a two-dimensional tensor, etc.) of a tensor (e.g., weight tensor corresponding to weight parameters of a machine-learned model), and separately quantizing each channel based on the determined minima and maxima.

In some instances, quantized operations can include generating a quantized value (e.g., model parameter value) based on a corresponding unquantized value. Generating a quantized value can include scaling, rounding, or offsetting an unquantized value (e.g., model parameter, etc.) to generate a corresponding quantized value. For example, in some instances, quantizing a value (e.g., machine-learned model parameter, etc.) can include rounding the value to the nearest mapped value of sixteen mapped unquantized values of a four-bit binary representation

$$( e . g . , rounding to ( min + 5 \frac{max - min}{14} ) , etc . ) .$$

As another example, in some instances, quantizing a value can include scaling or offsetting the value to map the value from an unquantized numerical range (e.g., min to max range) to an unchanging set of mapped numbers associated with a four-bit binary format (e.g., {−7.0, −6.0, −5.0, −4.0, −3.0, −2.0, −1.0, −0.25, 0.25, 1.0, 2.0, 3.0, 4.0, 5.0, 6.0, 7.0}, etc.). For example, scaling a value can include multiplying the value by

$$\frac{7. - ( - 7. )}{max - min}$$

to convert from a min-to-max scale to a −7.0 to +7.0 scale. Offsetting a scaled value can include adding −7.0−(min*scale), where scale is the value

$$( e . g . , \frac{7.0 - ( - 70 )}{max - min} , etc . )$$

used to scale the unquantized value. In some instances, an offset scaled value can then be rounded to a nearest mapped number (e.g., −5.0, etc.) of the unchanging set of mapped numbers.

In some instances, quantized operations can include generating an unquantized value based on a corresponding quantized value. In some instances, generating an unquantized value can include outputting a numerical value

$$( e . g . , 3. , ( min + 10 \frac{max - min}{14} ) , etc . )$$

corresponding to a binary input value having a four-bit binary format. In some instances, generating an unquantized value can further include scaling or offsetting the numerical value

$$( e . g . , substracting - 7.0 - \frac{min}{scale} , multiplying by \frac{1}{scale} , etc . )$$

based on a minimum and maximum unquantized value (e.g., per-channel minimum and maximum, etc.).

In some instances, a hardware device for performing computing operations using example four-bit binary formats can include a register. For example, in some instances, a circuit comprising one or more registers can receive (e.g., from a memory device such as high-bandwidth memory associated with a processor device comprising the register, etc.) a four-bit binary representation value (e.g., 1100, etc.) in a four-bit binary format. Based on the input value, the circuit can retrieve a mapped numerical value corresponding to the four-bit binary representation

$$( e . g . , 4. , ( min + 11 \frac{max - min}{14} ) , etc . )$$

from a register and output the mapped numerical value. In some instances, the mapped numerical value can include a numerical value represented in a number of bits greater than four (e.g., 6, 8, 16, 32, etc.) according to a binary format that is different from the four-bit binary format (e.g., 6-bit, 8-bit, or 16-bit integer; 16-bit or 32-bit floating-point; etc.). In some instances, the register can pass the mapped numerical value to one or more other hardware devices (e.g., multipliers, arithmetic logic units, matrix multiplication units, processor devices, etc.) to perform additional operations using the mapped numerical value (e.g., matrix multiplication operations, machine learning operations, etc.).

Example implementations of some aspects of the present disclosure can provide a variety of technical effects and benefits, such as improvements to computing technology (e.g., machine learning technology, matrix multiplication technology, computer hardware devices, etc.). For example, in some instances, example implementations according to some aspects of the present disclosure can provide reduced computational costs compared to some alternative systems and methods. In some instances, example implementations according to some aspects of the present disclosure provide improved technical performance compared to some alternative methods, such as improved accuracy of a quantized machine-learned model.

For example, in some instances, performing computing operations (e.g., machine learning operations, etc.) using four-bit binary representations can reduce a computational cost of the operations compared to some alternative systems and methods (e.g., alternative implementations using eight-bit, 16-bit, or 32-bit binary representations, etc.). For example, in some instances, storing and retrieving a four-bit value (e.g., quantized value, etc.) from memory can be performed at reduced computational cost (e.g., electricity cost, memory footprint, memory bandwidth, interconnection bandwidth, etc.) compared to retrieving values represented using a higher number of bits (e.g., eight, 16, 32, etc.). For example, in some instances, a plurality of four-bit values can be retrieved via high-bandwidth memory; converted (e.g., using one or more registers, etc.) to one or more higher-precision numerical values (e.g., six-bit, eight-bit, or sixteen-bit numerical values, etc.); and a computing operation can be performed (e.g., using a multiplier adjacent to the register) using the higher-precision numerical values. In this manner, for instance, memory and interconnection bandwidth usage can be reduced by using low-computational-cost register hardware to convert one or more numerical values immediately before a computing operation is performed.

In some instances, using four-bit binary representations can improve a technical performance (e.g., computational speed performance such as latency, throughput, etc.) of one or more computing operations compared to some alternative implementations (e.g., using eight-, 16-, or 32-bit representations, etc.). For example, in some computing operations (e.g., machine learning operations requiring a large number of parameters to be loaded from high-bandwidth memory), memory bandwidth may act as a latency bottleneck or throughput bottleneck, such that reducing memory bandwidth may improve a latency or throughput associated with the computing operations (e.g., without modifying any other aspect of the computation, such as a number of bits used to perform a corresponding floating-point operation, etc.).

In some instances, example four-bit binary representations according to some aspects of the present disclosure can provide improved technical performance (e.g., machine-learned inference accuracy, etc.) compared to some alternative four-bit binary representations. For example, in some experiments according to aspects of the present disclosure, a plurality of four-bit representations was used to train a plurality of machine-learned models using quantization-aware training to generate a plurality of quantized machine-learned models. The quantized machine-learned models were then tested for inference accuracy. In the example experiments, a quantized machine-learned model trained using a four-bit binary format mapping the sixteen binary representations to the numerical values {−7.0, −6.0, −5.0, −4.0, −3.0, −2.0, −1.0, −0.25, 0.25, 1.0, 2.0, 3.0, 4.0, 5.0, 6.0, 7.0} had higher accuracy compared to models trained using some alternative four-bit binary formats (e.g., floating-point or floating-point-like formats having one or more exponent bits; integer or integer-like formats; format based on a Gaussian probability distribution; etc.). Thus, some four-bit binary data formats according to aspects of the present disclosure can provide improved technical performance (e.g., machine-learned inference accuracy) compared to some alternative binary data formats.

Additionally, improving a technical performance can in some instances enable improvements in computational cost. For example, in some instances, an inference accuracy associated with a machine-learned model can scale with a number of parameters of the machine-learned model, a number of bits used to represent each parameter of the machine-learned model, or other scaling factor. Thus, in some instances, an improvement that enables improved accuracy using a same-size (e.g., number of parameters, number of bits per parameter, etc.) machine-learned model can enable using a reduced-size machine-learned model to achieve a similar (e.g., same) technical performance. In some instances, a computational cost (e.g., electricity cost, memory footprint, memory bandwidth, processor usage, etc.) can be proportional to a model size, and reducing the model size can therefore reduce a computational cost of machine learning operations. In this manner, for instance, accuracy improvements provided by example four-bit binary data formats according to some aspects of the present disclosure can enable machine learning operations of a given accuracy level at a reduced computational cost compared to some alternative implementations.

As another example, a latency or throughput associated with a machine learning operation can in some instances scale with a number of processing devices used to perform the machine-learning operation in parallel. For example, adding more processors may increase a throughput or reduce a latency of some computing operations. However, increasing a number of processors used to perform a computation may increase a computational cost (e.g., communication bandwidth, etc.) of the computation, such as by increasing a communication overhead associated with inter-processor communication. In some instances, systems and methods that can enable improved latency or throughput for a given processor count can also enable a reduced processor count for a given latency or throughput. In this manner, for instance, systems and methods according to some aspects of the present disclosure can perform some computing operations (e.g., quantized machine learning operations) at reduced computational cost (e.g., electricity cost, hardware cost, communication bandwidth, etc.) compared to some alternative methods.

Various example implementations are described herein with respect to the accompanying Figures.

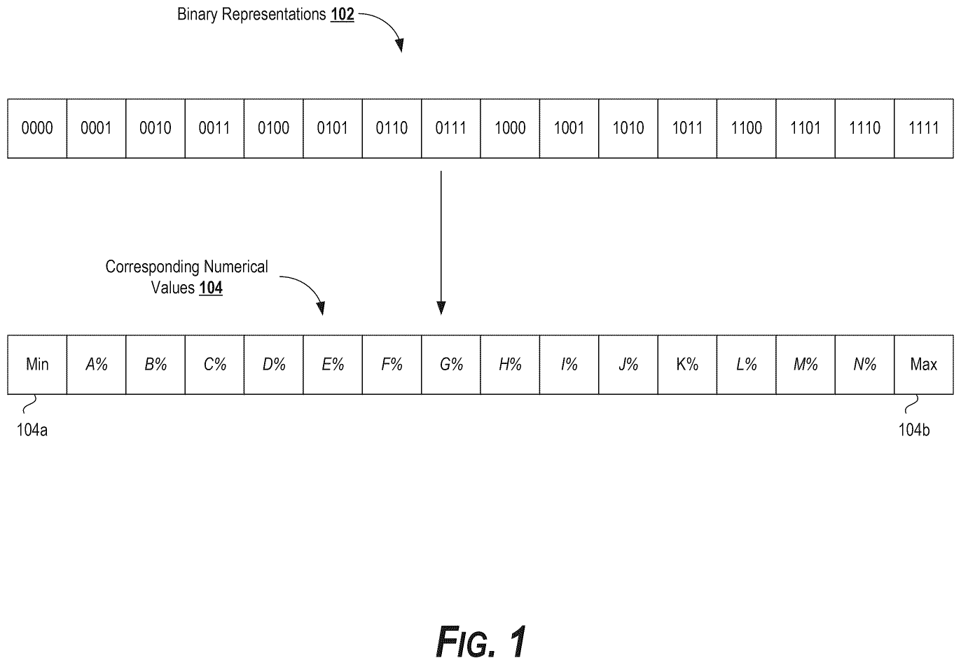

FIG. 1 is a block diagram illustrating an example four-bit binary data format according to example implementations of aspects of the present disclosure. A four-bit binary data format can correlate a plurality of binary representations 102 to a plurality of corresponding numerical values 104.

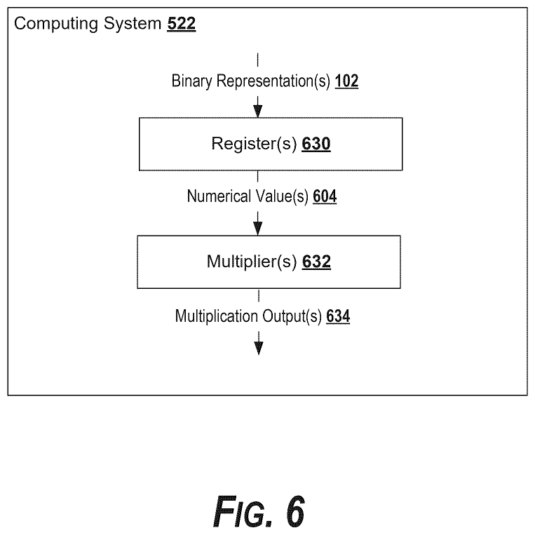

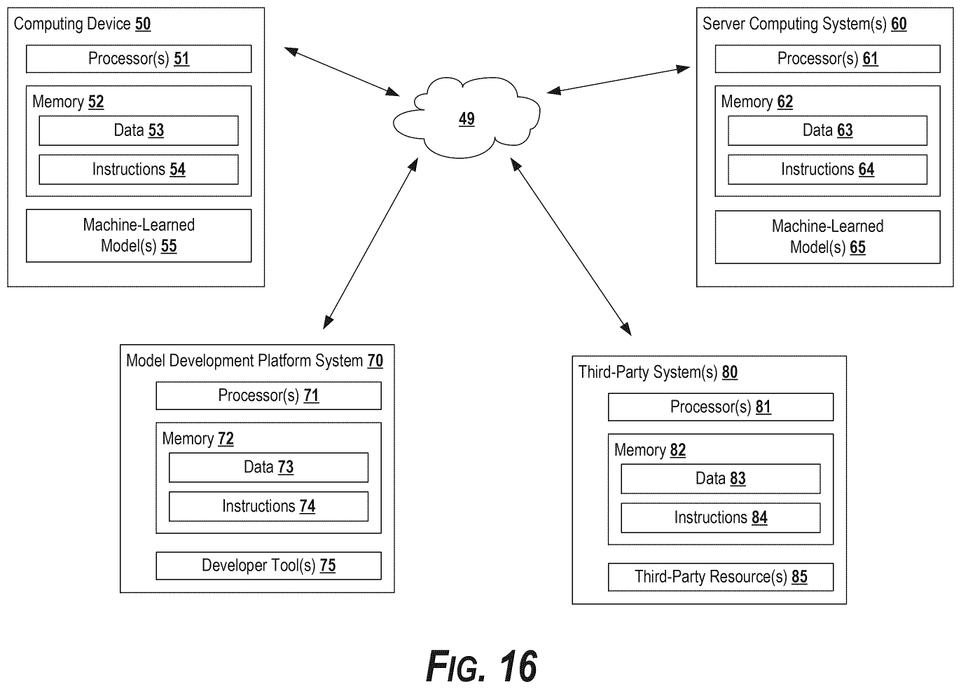

The binary representations 102 can be, for example, the sixteen four-bit binary values {0000, 0001, 0010, 0011, 0100, 0101, 0110, 0111, 1000, 1001, 1010, 1011, 1100, 1101, 1110, 1111}. The binary representations 102 can be embodied in any device, system, media, or other means for communicating, storing, retrieving, or otherwise performing operations on binary data. Further details of some example systems, devices, and components for storing, communicating, and operating on binary data are provided below with respect to FIGS. 6 and 16.

The numerical values 104 can be, for example, a plurality of sixteen numerical values. In some instances, each of the sixteen numerical values 104 can be a distinct numerical value (e.g., distinct finite numerical value). In some instances, the four-bit binary data format can lack any binary representation 102 for representing any “special” values that are not between a finite minimum 104a and maximum 104b, such as infinity, negative infinity, not-a-number, or negative zero. In some instances, the numerical values can comprise a range of numerical values between a minimum value 104a and maximum value 104b inclusive. In some instances, each numerical value other than the minimum value 104a and maximum value 104b can be between the minimum value 104a and maximum value 104b exclusive.

In some instances, the numerical values 104 can be fixed values (e.g., −7.0, −5.0, etc.) or relative values based on the minimum value 104a and maximum value 104b

$$( e . g . , min + \frac{A}{100} ( max - min ) , etc . ) .$$

For example, in some instances, a numerical value 104 (e.g., fixed value, relative value, etc.) can be represented as a percentage on a scale from a minimum value 104a to a maximum value 104b, wherein the minimum value 104a is treated as zero percent on the scale, and the maximum value 104b is treated as 100 percent on the scale. As a non-limiting illustrative example, the numbers {−7.0, −6.0, −5.0, −4.0, −3.0, −2.0, −1.0, −0.25, 0.25, 1.0, 2.0, 3.0, 4.0, 5.0, 6.0, 7.0} may also be represented as {0 percent, 7.14 percent, 14.28 percent, 21.43 percent, 28.57 percent, 35.71 percent, 42.86 percent, 48.21 percent, 51.79 percent, 57.14 percent, 64.28 percent, 71.43 percent, 78.57 percent, 85.71 percent, 92.86 percent, and 100 percent} on a scale of −7.0 to 7.0. As another example, the percentages depicted in FIG. 1 (e.g., 4%, B %, etc.) can each correspond to a numerical value according to the formula

$$min + \frac{pct}{100} ( max - min ) ,$$

where pct is a percentage value (e.g., A %, B %, etc.).

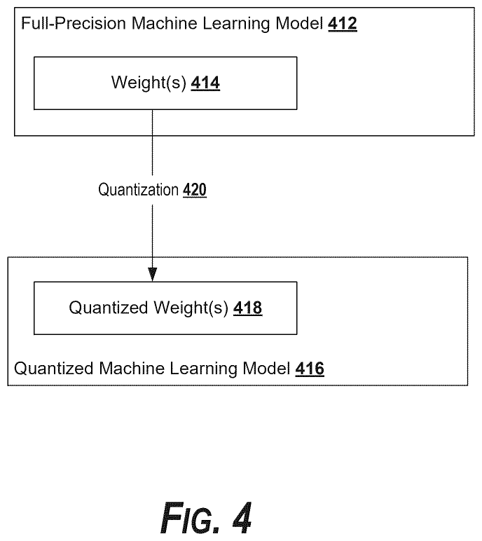

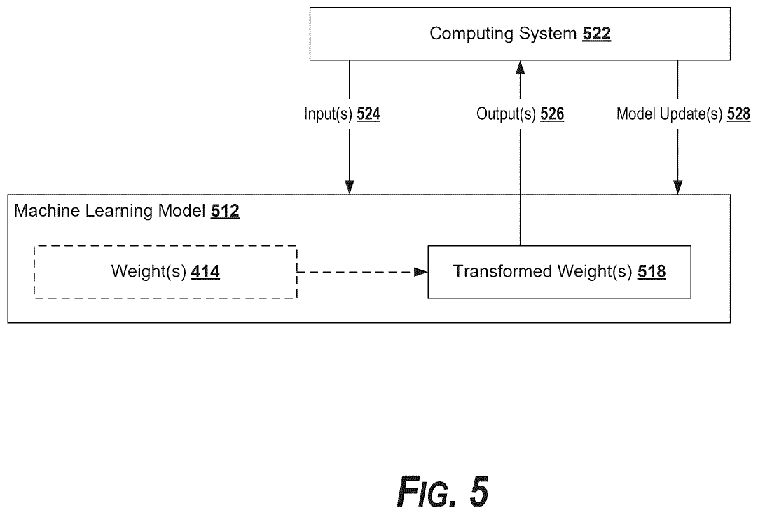

In some instances, a set of relative numerical values 104 represented as a plurality of percentages can be rescaled to a new scale based on a new minimum value 104a and maximum value 104b. For example, in some instances, a computing system can obtain (e.g., retrieve, receive, determine, etc.) a minimum value 104a and maximum value 104b for a particular computing operation (e.g., machine learning operation, etc.); and can apply a set of relative numerical values 104 to the scale to generate a set of absolute numerical values to be represented by the binary representations 102. Further details of some example operations for obtaining example minimum values 104a and maximum values 104b according to some example aspects of the present disclosure are provided below with respect to FIGS. 4 and 5.

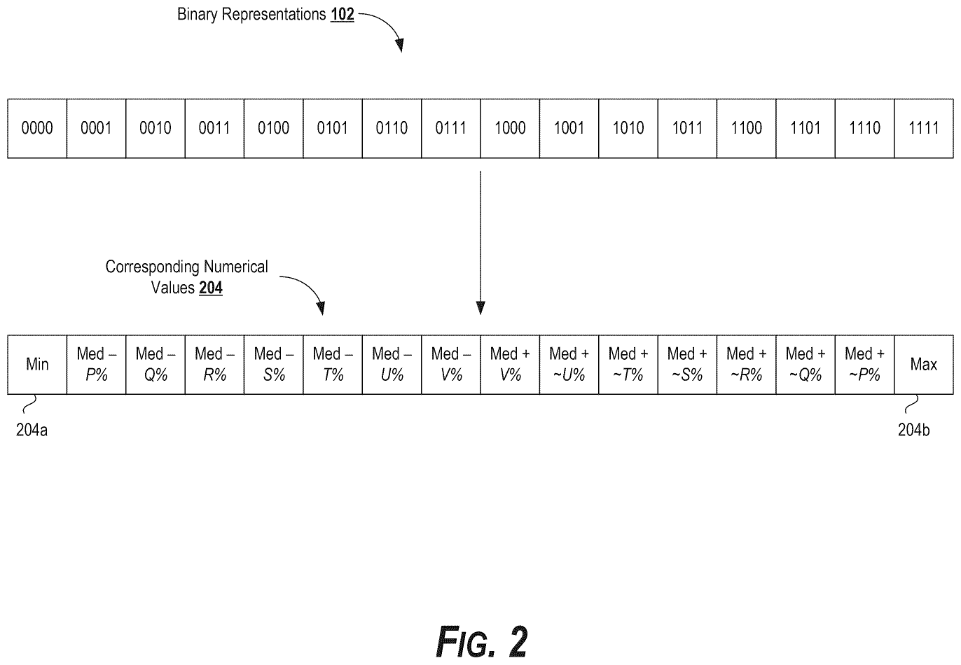

FIG. 2 is a block diagram illustrating an example four-bit binary data format according to example implementations of aspects of the present disclosure. A four-bit binary data format can map a plurality of binary representations 102 to a plurality of corresponding numerical values 204. In some instances, the numerical values can comprise a range of numerical values between a minimum value 204a and maximum value 204b inclusive. In some instances, each numerical value 204 other than the minimum value 204a and maximum value 204b can be between the minimum value 104a and maximum value 204b exclusive. In some instances, the numerical values 204 can be fixed values (e.g., −5.0, etc.) or relative values based on the minimum value 204a and maximum value 204b

$$( e . g . , min + \frac{A}{100} ( max - min ) , etc . ) .$$

In some instances, the numerical values 204 can be symmetrical about a median value (e.g., zero, etc.). In some instances, the numerical values 204 can have one or more other properties that are similar to (e.g., same as, etc.) one or more properties of the numbers {−7.0, −6.0, −5.0, −4.0, −3.0, −2.0, −1.0, −0.25, 0.25, 1.0, 2.0, 3.0, 4.0, 5.0, 6.0, 7.0}.

In some instances, numerical values 204 can be, comprise, be comprised by, or otherwise share one or more properties with numerical values 104. For example, in some instances, a numerical value 204 can have any property described above with respect to a numerical value 104.

In some instances, a set of sixteen numerical values 204 can be approximately symmetrical about a median value. For example, a median of sixteen numerical values can be defined as half of a sum of an eighth highest value and a ninth highest value of the sixteen values. An approximately symmetrical set of numerical values 204 can include, for example, a set of numerical values 204 wherein each pair of an i^{th} highest and i^{th} lowest value is approximately the same distance from the median. For example, a difference (e.g., absolute numerical difference, percentage difference on a scale from minimum 104a to maximum 104b, etc.) between an i^{th} highest value of a set of numerical values 204 and a median of the set of numerical values 204 can be approximately equal to (e.g., within 30 percent of, such as within 20 percent of, such as within 15 percent of, such as within 10 percent of, such as within 5 percent of, such as within 2 percent of, such as within 1 percent of, etc.) a difference between the median and an i^{th} lowest value of the set of numerical values 204. Similarly, a difference between an i^{th} highest value of a set of numerical values 204 and a median of the set of numerical values 204 can be approximately equal to (e.g., within 30 percent of, such as within 20 percent of, such as within 15 percent of, such as within 10 percent of, such as within 5 percent of, such as within 2 percent of, such as within 1 percent of, etc.) half of a difference between the i^{th} highest value of a set of numerical values 204 and an i^{th} lowest value of the set of numerical values 204. In some instances, a set of sixteen numerical values 204 can include eight pairs (e.g., pairs of i^{th} highest and i^{th} lowest values, where i is between 1 and 8 inclusive) of numerical values 204 having a higher numerical value 204 and lower numerical value 204, wherein for each pair of the eight pairs, a difference between the higher value and the median is about 50 percent of a difference between the higher value and the lower value.

In some instances, one or more percentage values on a min-to-max scale associated with any combination of one or more i^{th} highest values of a set of numerical values 204 can be approximately equal to (e.g., within 30 percent of, such as within 20 percent of, such as within 15 percent of, such as within 10 percent of, such as within 5 percent of, such as within 2 percent of, such as within 1 percent of, etc.) one or more corresponding percentage values on a −7.0 to 7.0 scale of the set of numerical values {−7.0, −6.0, −5.0, −4.0, −3.0, −2.0, −1.0, −0.25, 0.25, 1.0, 2.0, 3.0, 4.0, 5.0, 6.0, 7.0}. For example, a 15th highest value can correspond to approximately 7.14 percent on a min-to-max scale associated with a set of numerical values 204 (e.g., min+0.0714*(max−min). Similar, a 14^{th}, 13^{th}, 12^{th}, 11^{th}, 10^{th}, 9^{th}, 8^{th}, 7^{th}, 6^{th}, 5^{th}, 4^{th}, 3^{th} or 2^{th} highest value can correspond to approximately 14.28 percent, 21.43 percent, 28.57 percent, 35.71 percent, 42.86 percent, 48.21 percent, 51.79 percent, 57.14 percent, 64.28 percent, 71.43 percent, 78.57 percent, 85.71 percent, or 92.86 percent respectively on a min-to-max scale characterized by a minimum value 204a at zero percent and maximum value 204b at 100 percent.

In some instances, a plurality of step sizes between numerical values can be approximately equal to (e.g., within 30 percent of, such as within 20 percent of, such as within 15 percent of, such as within 10 percent of, such as within 5 percent of, such as within 2 percent of, such as within 1 percent of, etc.) the following values:

$$[ \frac{1}{14} , \frac{1}{14} , \frac{1}{14} , \frac{1}{14} , \frac{1}{14} , \frac{1}{14} , \frac{3}{56} , \frac{2}{56} , \frac{3}{56} , \frac{1}{14} , \frac{1}{14} , \frac{1}{14} , \frac{1}{14} , \frac{1}{14} , \frac{1}{14} ]$$

of a difference between a minimum and maximum value of a set of numerical values 204. As used herein, a “step size” can refer to a difference between adjacent numerical values 204 (e.g., between an i^{th} lowest value and (i+1)^{th} lowest value) of a set of numerical values 204. As used herein, a list of step sizes in brackets

$$( e . g . , [ \frac{1}{14} , \frac{1}{14} , \frac{1}{14} , \frac{1}{14} , \frac{1}{14} , \frac{1}{14} , \frac{3}{56} , \frac{2}{56} , \frac{3}{56} , \frac{1}{14} , \frac{1}{14} , \frac{1}{14} , \frac{1}{14} , \frac{1}{14} , \frac{1}{14} ] )$$

can refer to an ordered list of differences between an i^{th} lowest value and (i+1)^{th} lowest value, wherein a first entry of the list corresponds to i=1, a second entry corresponds to i=2, and so on.
a ratio of each step size of the sixteen numerical values to a difference between a highest value and lowest value of the sixteen numerical values is within 30 percent of:

In some instances, one or more differences between pairs of i^{th} highest and j^{th} highest percentage values on a min-to-max scale associated with a set of numerical values 204 can be approximately equal to (e.g., within 30 percent of, such as within 20 percent of, such as within 15 percent of, such as within 10 percent of, such as within 5 percent of, such as within 2 percent of, such as within 1 percent of, etc.) one or more corresponding differences between i^{th} highest and j^{th} highest percentage values on a −7.0 to 7.0 scale of the set of numerical values {−7.0, −6.0, −5.0, −4.0, −3.0, −2.0, −1.0, −0.25, 0.25, 1.0, 2.0, 3.0, 4.0, 5.0, 6.0, 7.0}, where i and j are integers. For example, a difference between 16^{th} and 15^{th}, 15^{th} and 14^{th}; 14^{th} and 13^{th}, 13^{th} and 12^{th}; 12^{th} and 11^{th}, 11^{th} and 10^{th}, 7^{th} and 6^{th}, 6^{th} and 5^{th}, 5^{th} and 4^{th}; 4^{th} and 3^{rd}, 3^{rd} and 2^{nd}, or 2^{nd} and 1^{st} highest values of a set of numerical values 204 can be approximately equal to 7.14 percent or 1/14 of a difference between a maximum value 104b and minimum value 104a. As another example, a difference between a 10^{th} highest and 9^{th} highest value or 8^{th} highest and seventh highest value can be approximately equal to 3/56 or 5.36 percent of a difference between a maximum value 204b and minimum value 204a. As another example, a difference between a 9^{th} highest value and an eighth highest value can be approximately equal to 1/28 or 3.57 percent of a difference between a maximum value 204b and minimum value 204a. As another example, a difference between an i^{th} highest and j^{th} highest value, wherein i and j differ by 2 and are either both greater than 9 or both less than 8, can be approximately 14.28 percent of a difference between a maximum value 204b and minimum value 204a. As another example, a difference between an i^{th} highest and j^{th} highest value, wherein i and j differ by 3 and are either both greater than 9 or both less than 8, can be approximately 21.43 percent of a difference between a maximum value 204b and minimum value 204a. As another example, a difference between an i^{th} highest and j^{th} highest value, wherein i and j differ by 4 and are either both greater than 9 or both less than 8, can be approximately 28.57 percent of a difference between a maximum value 204b and minimum value 204a. As another example, a difference between an i^{th} highest and j^{th} highest value, wherein i and j differ by 5 and are either both greater than 9 or both less than 8, can be approximately 35.71 percent of a difference between a maximum value 204b and minimum value 204a. As another example, a difference between an i^{th} highest and j^{th} highest value, wherein i and j differ by 6 and are either both greater than 9 or both less than 8, can be approximately 42.86 percent of a difference between a maximum value 204b and minimum value 204a. As another example, a difference between an i^{th} highest and j^{th} highest value can be approximately (|i−j|*7.14−adjustment) percent of a difference between a maximum value 204b and minimum value 204a, wherein adjustment can be equal to 1.79 if exactly one of 8 and 9 is between i and j inclusive; 7.14 if both 8 and 9 are between i and j exclusive; and 5.36 if 8 and 9 are each between i and j inclusive but are not both between i and j exclusive.

As used herein, the phrase “approximately equal to” and similar terms, including but not limited to “about” or “about equal to,” can refer to within 30 percent of, such as within 20 percent of, such as within 15 percent of, such as within 10 percent of, such as within 5 percent of, such as within 2 percent of, such as within 1 percent of, and the like. As a non-limiting illustrative example, 30 percent of 7 percent can refer to 2.1 percent, and within 30 percent of 7 percent can refer to any value between 4.9 and 9.1 percent inclusive.

In some instances, one or more ratios between one or more first differences between an i^{th} highest and j^{th} highest percentage value and one or more second differences between a k^{th} highest and l^{th} highest percentage value on a min-to-max scale associated with a set of numerical values 204 can be approximately equal to (e.g., within 30 percent of, such as within 20 percent of, such as within 15 percent of, such as within 10 percent of, such as within 5 percent of, such as within 2 percent of, such as within 1 percent of, etc.) one or more corresponding ratios between one or more first differences between an i^{th} highest and j^{th} highest percentage value and one or more second differences between a k^{th} highest and (h highest percentage value on a −7.0 to 7.0 scale of the set of numerical values {−7.0, −6.0, −5.0, −4.0, −3.0, −2.0, −1.0, −0.25, 0.25, 1.0, 2.0, 3.0, 4.0, 5.0, 6.0, 7.0}. For example, a ratio between any pair of differences wherein |i−j|=|k−l| and adjustmentᵢⱼ=adjustmentₖₗ can be approximately equal to one, wherein adjustmentᵢⱼ can be equal to 1.79 if exactly one of 8 and 9 is between i and j inclusive; 7.14 if both 8 and 9 are between i and j exclusive; and 5.36 if 8 and 9 are each between i and j inclusive but are not both between i and j exclusive, and wherein adjustmentₖₗ is equal to 1.79 if exactly one of 8 and 9 is between k and l inclusive; 7.14 if both 8 and 9 are between k and l exclusive; and 5.36 if 8 and 9 are each between k and l inclusive but are not both between k and l exclusive.

In some instances, a set of numerical values 204 can be scaled or offset to any appropriate scale without deviating from the scope of the present disclosure. As a non-limiting illustrative example, for some computing operations according to some aspects of the present disclosure (e.g., some quantized machine learning operations), a first set of numerical values 204 {−7.0, −6.0, −5.0, −4.0, −3.0, −2.0, −1.0, −0.25, 0.25, 1.0, 2.0, 3.0, 4.0, 5.0, 6.0, 7.0} can be equivalent to a second set of numerical values 204 {−28, −24, −20, −16, −12, −8, −4, −1, 1, 4, 8, 12, 16, 20, 24, 28}, which correspond to multiplying each numerical value 204 of the first set by four. Any such scaling factor may be used without deviating from the scope of the present disclosure. As another example, for some computing operations according to some aspects of the present disclosure, a first set of numerical values 204 {−7.0, −6.0, −5.0, −4.0, −3.0, −2.0, −1.0, −0.25, 0.25, 1.0, 2.0, 3.0, 4.0, 5.0, 6.0, 7.0} can be equivalent to a second set of numerical values 204 {−7.5, −6.5, −5.5, −4.5, −3.5, −2.5, −1.5, −0.75, −0.25, 0.5, 1.5, 2.5, 3.5, 4.5, 5.5, 6.5}, which corresponds to subtracting 0.5 from each numerical value 204 of the first set. Any such offset (e.g., alone or in combination with a scaling factor) may be used without deviating from the scope of the present disclosure.

In some instances, a numerical value 204 can be embodied in any device, system, media, or other means for communicating, storing, retrieving, or otherwise performing operations on binary data. Further details of some example systems, devices, and components for storing, communicating, and operating on binary data are provided below with respect to FIGS. 6 and 16.

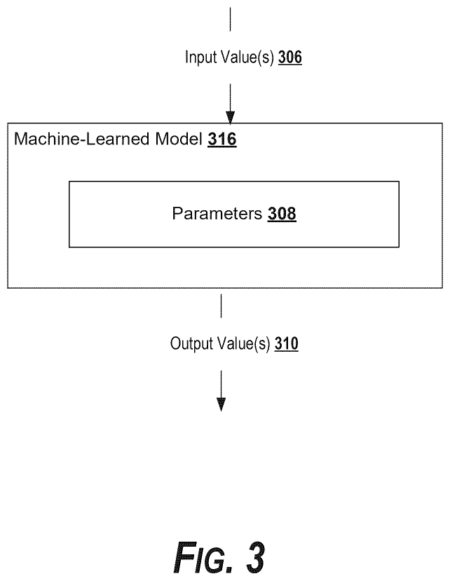

In some instances, an embodiment of a numerical value 204 can represent the numerical value in any binary format, which may be the same as or different from the binary representations 102. For example, in some instances, a binary representation 102 can be converted to a numerical value 104, 204 represented in a binary format (e.g., higher-precision binary format such as 6-bit, 8-bit, 16-bit, 32-bit, or 64-bit binary format) that is different from a four-bit binary format associated with the binary representation 102. In some instances, such a converted value may be used in one or more additional computing operations (e.g., arithmetic operations, matrix multiplication operations, machine learning operations, etc.). Further details of some example operations that may use numerical values 204 are provided below with respect to FIGS. 3 through 6.

Although FIGS. 1 and 2 illustrate example four-bit binary formats, a binary format can in some instances use a number of bits greater or less than four without going outside the scope of the present disclosure. For example, in some instances, a binary format can include a two-bit binary format mapping four binary values to four corresponding numerical values; a three-bit binary format mapping eight binary values to eight corresponding numerical values; a five-bit binary format mapping 32 binary values to 32 corresponding numerical values; a six-bit binary format mapping 64 binary values to 64 corresponding numerical values; a seven-bit binary format mapping 128 binary values to 128 corresponding numerical values; an eight-bit binary format mapping 256 binary values to 256 corresponding numerical values; and the like. In some instances, a two-, three-, five-, six-, seven-, or eight-bit binary format according to the present disclosure can have any property described above with respect to a four-bit binary format. For example, such a binary format can be symmetric about a median; can have a non-uniform step size; can have a larger step size near each end of a range of numerical values and a smaller step size near a median; can have an approximately uniform step size near each end of a range of numerical values and a different (e.g., smaller) step size near a median; can have a step size near a median that is approximately 0.75 or 0.5 times a step size near an end; or can have any other property described herein.

FIG. 3 is a block diagram of an example system for performing machine-learned inference using a four-bit binary data format according to example implementations of aspects of the present disclosure. One or more inputs 306 can be provided to a machine-learned model 316 having one or more parameters 308 represented according to a four-bit binary format (e.g., format described above with respect to FIGS. 1 and 2). Based at least in part on the input values 306 and parameters 308, the machine-learned model 316 can generate one or more output values 310.

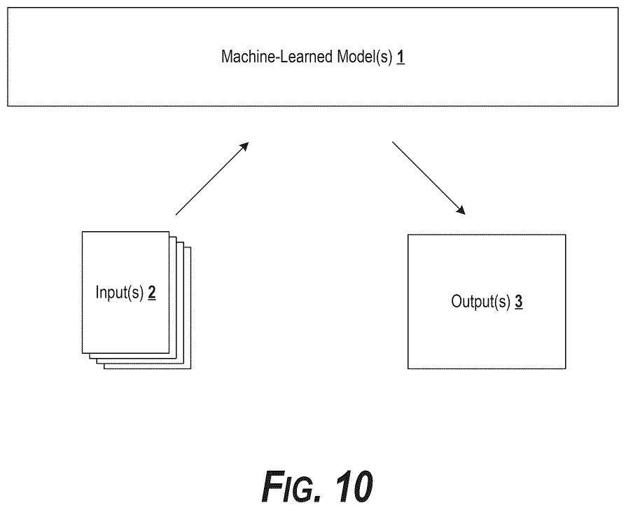

Input value(s) 306 can generally include or otherwise represent various types of data. For example, in some instances, input value(s) 306 can have any property described below with respect to input(s) 2 of FIG. 10. In some instances, input value(s) 306 can include one or more sequence inputs (e.g., natural language sequence inputs, etc.) configured to be input to a sequence processing model (e.g., language model, etc.). In some instances, input value(s) 306 can include inputs associated with a four-bit binary format, such as binary representations 102 or numerical values 104, 204.

Parameter(s) 308 can include, for example, one or more values associated with a four-bit binary format (e.g., binary representations 102, numerical values 104, 204, etc.). In some instances, parameter(s) 308 can include parameters that are stored as binary representations 102 and converted to corresponding numerical values 104, 204 during a machine learning computation (e.g., inference, training, etc.). In some instances, parameters 308 can include weights of a machine-learned model (e.g., weights of a machine-learned model layer, etc.), such as weights to be multiplied by one or more input activations (e.g., using matrix multiplication) associated with a machine-learned model layer. In some instances, parameter(s) 308 can also include one or more values that are not associated with a four-bit binary format (e.g., 8-bit, 16-bit, or 32-bit numerical values; non-numerical parameter values; etc.).

Output value(s) 310 can generally include or otherwise represent various types of data. For example, in some instances, output value(s) 310 can have any property described below with respect to output(s) 3 of FIG. 10. In some instances, output value(s) 310 can include one or more sequence outputs (e.g., natural language sequence inputs; audio, video, or image generation outputs; etc.) or other outputs of a sequence processing model. In some instances, output value(s) 310 can include values associated with a four-bit binary format, such as binary representations 102 or numerical values 104, 204. In some instances, output value(s) 310 can have a data type that is the same as or different from a data type of input value(s) 306.

A machine-learned model 316 can include one or more machine-learned models. The machine-learned model 316 can include various model architectures, such as various neural network model architectures. An example model architecture for a machine-learned model 316 can include a sequence processing model architecture (e.g., a transformer model, selective structured state space model, etc.). For example, the machine-learned model 316 can be configured to receive an input sequence and generate an output sequence. For instance, the machine-learned model 316 can be configured to generate an output sequence where elements of the output sequence are predicted based on the elements of the input sequence. In some instances, a machine-learned model 316 can include a generative sequence processing model, such as a generative natural language model (e.g., text-based, audio-based, multimodal, etc.) or other generative model (e.g., image generation, audio generation, or video generation model, etc.). In some instances, a machine-learned model 316 can include a model architecture having an attention mechanism (e.g., self-attention). In some instances, the machine-learned model 316 be a pre-trained model (e.g., pretrained using large-scale unsupervised learning). In some instances, the machine-learned model 316 can be fine-tuned over one or more fine-tuning datasets, such as a fine-tuning dataset associated with one or more specialized generation tasks.

Although FIG. 3 depicts a machine learning computation wherein one or more of the input values 306, parameters 308, and output values 310 may have the four-bit binary format, various non-machine-learning computations can be performed without deviating from the scope of the present disclosure. For example, in some instances, a computing system or component thereof (e.g., processor device, register, matrix multiplication unit, etc.) can obtain (e.g., receive, generate, retrieve from memory, etc.) one or more binary input values having a binary format according to example implementations of some aspects of the present disclosure; and generate, based on one or more numerical input values corresponding to the one or more binary input values according to the binary format, an output value. In some instances, a memory bottleneck associated with a memory-bottlenecked computation (e.g., non-machine-learning computation such as scientific computing operation, high-performance computing operation, parallel computing operation, data-intensive computing operation, etc.) can be mitigated by quantizing one or more data values (e.g., input values, output values, parameter values, etc.) associated with the computation (e.g., according to a binary format described herein), and performing the computation according to one or more methods described herein.

FIG. 4 is a block diagram of an example system for quantizing a machine learning model according to example implementations of aspects of the present disclosure. A full-precision machine learning model 412 can have one or more weights 414. A quantization 420 can be performed on the weights 414 to generate one or more quantized weights 418, which can be parameters of a quantized machine learning model 416 associated with the full-precision machine learning model.

The full-precision machine learning model 412 can include one or more machine-learned models. The full-precision machine learning model 412 can include various model architectures, such as various neural network model architectures. An example model architecture for a full-precision machine learning model 412 can include a sequence processing model architecture (e.g., a transformer model, selective structured state space model, etc.). For example, the full-precision machine learning model 412 can be configured to receive an input sequence and generate an output sequence. For instance, the full-precision machine learning model 412 can be configured to generate an output sequence where elements of the output sequence are predicted based on the elements of the input sequence. In some instances, a full-precision machine learning model 412 can include a generative sequence processing model, such as a generative natural language model (e.g., text-based, audio-based, multimodal, etc.) or other generative model (e.g., image generation, audio generation, or video generation model, etc.). In some instances, a full-precision machine learning model 412 can include a model architecture having an attention mechanism (e.g., self-attention). In some instances, the full-precision machine learning model 412 can be a pre-trained model (e.g., pretrained using large-scale unsupervised learning). In some instances, the full-precision machine learning model 412 can be fine-tuned over one or more fine-tuning datasets, such as a fine-tuning dataset associated with one or more specialized generation tasks.

In some instances, the full-precision machine learning model 412 can include one or more parameters (e.g., weights) represented in a binary format that uses more than four bits (e.g., eight bits, 16 bits, 32 bits, 64 bits, etc.) to represent each number.

The weights 414 can include parameters of the full-precision machine learning model 412, such as weights of the full-precision machine learning model 412. In some instances, the weights 414 can include neural network weights configured to be multiplied by one or more input activations (e.g., using matrix multiplication) before being summed and provided to an activation function (e.g., sigmoid or logistic activation function, rectified linear unit activation function, etc.). In some instances, one or more (e.g., all, etc.) of the weights 414 can be stored, transmitted, or otherwise represented in a binary format that uses more than four bits (e.g., eight bits, 16 bits, 32 bits, 64 bits, etc.) per weight 414.

The quantized machine learning model 416 can include one or more machine-learned models. The quantized machine learning model 416 can include various model architectures, such as various neural network model architectures. An example model architecture for a quantized machine learning model 416 can include a sequence processing model architecture (e.g., a transformer model, selective structured state space model, etc.). For example, the quantized machine learning model 416 can be configured to receive an input sequence and generate an output sequence. For instance, the quantized machine learning model 416 can be configured to generate an output sequence where elements of the output sequence are predicted based on the elements of the input sequence. In some instances, a quantized machine learning model 416 can include a generative sequence processing model, such as a generative natural language model (e.g., text-based, audio-based, multimodal, etc.) or other generative model (e.g., image generation, audio generation, or video generation model, etc.). In some instances, a quantized machine learning model 416 can include a model architecture having an attention mechanism (e.g., self-attention). In some instances, the quantized machine learning model 416 can be a pre-trained model (e.g., pretrained using large-scale unsupervised learning). In some instances, the quantized machine learning model 416 can be fine-tuned over one or more fine-tuning datasets, such as a fine-tuning dataset associated with one or more specialized generation tasks. In some instances, a quantized machine learning model 416 can be, comprise, be comprised by, or otherwise share one or more properties with a machine-learned model 316.

In some instances, the quantized machine learning model 416 can include one or more parameters (e.g., weights) represented in a binary format that uses four bits to represent each number, such as one or more four-bit binary formats described herein (e.g., with respect to FIGS. 1 and 2).

The quantized weights 418 can include parameters of the quantized machine learning model 416, such as weights of the quantized machine learning model 416. In some instances, the quantized weights 418 can include neural network weights configured to be multiplied by one or more input activations (e.g., using matrix multiplication) before being summed and provided to an activation function (e.g., sigmoid or logistic activation function, rectified linear unit activation function, etc.). In some instances, one or more (e.g., all, etc.) of the quantized weights 418 can be stored, transmitted, or otherwise represented in a binary format that uses four bits per quantized weight 418, such as one or more four-bit binary formats described herein (e.g., with respect to FIGS. 1 and 2). In some instances, quantized weights 418 can be, comprise, be comprised by, or otherwise share one or more properties with parameters 308.

However, in some instances, one or more quantized weights 418 can include parameters that are stored, transmitted, or otherwise represented in a binary format that uses more than four bits (e.g., eight bits, 16 bits, 32 bits, 64 bits, etc.) per quantized weight 418 without deviating from the scope of the present disclosure. For example, in some instances, a weight 418 can include a value that has been scaled, rounded, or otherwise transformed to correspond to a numerical value 104, 204 associated with a four-bit binary format, even if the numerical value 104, 204 is represented in a binary format that uses more than four bits. Additionally, in some instances, a quantized weight 418 can include a value that has been scaled, rounded, or otherwise transformed based on a four-bit binary format, even if the value is not exactly equal to a corresponding numerical value 104, 204.

Quantization 420 can include, for example, transforming a first value (e.g., weight 414) represented in a higher-precision (e.g., 8-bit, 16-bit, 32-bit, or 64-bit precision, etc.) binary format to a second value (e.g., weight 418) represented in a lower-precision (e.g., four-bit) binary format. In some instances, quantization 420 can include clipping, scaling, rounding, offsetting, or other quantization operation. In some instances, quantization 420 can include channel-wise quantization (e.g., based on a plurality of channel-wise minimum and maximum values, etc.) or other quantization scheme (e.g., tensor-wise, model-wise, static or universal quantization scheme applicable to a plurality of models, etc.).

In some instances, quantization 420 can include obtaining (e.g., determining, selecting, generating, retrieving, receiving, etc.) a scale (e.g., channel-wise scale, etc.) comprising a minimum value and maximum value associated with a plurality of values (e.g., weights 414) to be quantized. For example, in some instances, a quantization 420 can include identifying a largest parameter value of a plurality of parameter values (e.g., weights 414, etc.); identifying a smallest parameter value of the plurality of parameter values; and defining a scale based on the smallest and largest parameter values. For example, in some instances, the smallest parameter value can be the minimum value of the scale, and the largest parameter value can be the maximum value of the scale. Such smallest and largest parameter values can in some instances be referred to as “unclipped” minimum and maximum values.

In some instances, a plurality of parameters from which a minimum and maximum value are selected can include all of the parameters (e.g., weights 414) of one or more models, or can include a subset of the parameters of one or more models. For example, in some instances, a subset can be defined based on one or more layers of a machine learning model; one or more channels (e.g., tensor channels, input channels, activation channels, etc.) associated with a machine learning model or a tensor comprising a plurality of parameters; one or more rows, columns, or similar dimensional subset of a tensor comprising a plurality of parameters (e.g., one or more two-dimensional subsets of a three-dimensional tensors, etc.); or other appropriate subset.

For example, in some instances, quantization 420 can include channel-wise quantization, wherein parameters associated with a plurality of parameter channels (e.g., tensor channels) are quantized based on a plurality of scales having a minimum value and maximum value selected based on parameters associated with the corresponding channel. In some instances, a channel can include a plurality of parameters that are logically or numerically related (e.g., based on a property of input activations associated with the parameters such as red/green/blue channels of some image processing models, based on a dimension of a tensor comprising the parameters such as a column of a two-dimensional tensor, based on a numerical relationship such as a plurality of columns having similar minima and maxima, etc.). For example, in some instances, a parameter channel can include a column of a two-dimensional matrix of parameters or similar dimensional subset of a multi-dimensional tensor. In some instances, an input channel can include a plurality of columns (or similar dimensional subsets) having similar minima and maxima. In some instances, an input channel can include parameters (e.g., columns, etc.) from one layer or many layers of a corresponding machine learning model. For example, in some instances, a plurality of subsets of a plurality of tensors may be defined (e.g., by column, etc.), with each tensor comprising parameters of one or more machine learning model layers; a minimum and maximum of each subset may be determined; and the subsets may be grouped into channels based on the minima and maxima. For example, in some instances, subsets having similar minima and maxima, similar differences between minima and maxima, or the like can be grouped into channels. In some instances, a channel minimum and channel maximum can be determined after the channels are selected.

In some instances, determining a minimum value or maximum value can include clipping. For example, in some instances, a minimum value of a quantization scale can be greater than the smallest parameter value of a corresponding plurality of parameters, or a maximum value of a quantization scale can be less than the largest parameter value of a corresponding plurality of parameters. In some instances, a clipped minimum or maximum value of a scale can be determined based on one or more thresholds or percentile values. For example, in some instances, a clipped minimum or maximum value can include a parameter value associated with a particular percentile (e.g., fifth, tenth, 90^{th}, 95^{th}, 99^{th}, etc.) of a plurality of parameters (e.g., parameters of a channel, layer, machine-learned model, etc.). As another example, in some instances, clipping a minimum or maximum value can include comparing a smallest or largest parameter value of a plurality of parameters to one or more statistical outlier thresholds, such as a threshold based on one or more interquartile ranges (e.g., third quartile+1.5*interquartile range, etc.), standard deviations (e.g., z-score threshold of 3 or −3, etc.), or other statistical measures. As another example, in some instances, clipping a minimum or maximum value can include adjusting the minimum or maximum value according to a percentage of one or more values (e.g., percentage of a smallest or largest parameter value, percentage of a difference between the smallest and largest parameter value, etc.). Other examples are possible.

In some instances, quantization 420 can include scaling a first value to generate a scaled first value. Scaling the value can include, for example, scaling the first value based on a minimum unscaled value, maximum unscaled value, minimum scaled value, and maximum scaled value. As a non-limiting illustrative example, a minimum and maximum scaled value associated with a four-bit binary format can include −7.0 and 7.0, −7.5 and 7.5, −28 and 28, or other appropriate values. In some instances, a minimum and maximum scaled value can be equal to a highest and lowest numerical value 104 associated with a four-bit binary representation (e.g., one or more four-bit binary representations described above with respect to FIGS. 1 and 2). In some instances, a minimum and maximum scaled value can be different from a highest and lowest numerical value 104. For example, in some instances, a minimum and maximum scaled value can be determined based on a difference between numerical values 104. For example, in some instances, a minimum scaled value (e.g., −7.5) can be lower than a lowest numerical value 104 (e.g., −7.0, etc.) by an amount equal to half of a difference between a lowest and second lowest numerical value 104. In this manner, for instance, a plurality of scaled values can in some instances be divided into evenly spaced bins (e.g., bins having a scaled width of 1.0, etc.). Other implementations are possible. In some instances, an unscaled minimum or maximum value can be a clipped or unclipped minimum or maximum determined according to one or more methods described above. In some instances, scaling a value can include multiplying the value by

$$\frac{( scale Max - scale Min )}{( unscaled Max - unscaled Min )} .$$

In some instances, quantization 420 can include offsetting a first value or scaled first value. In some instances, offsetting can be based at least in part on a median of the scale; a median of one or more parameter values; one or more midpoints between a minimum and maximum value (e.g., scaled minimum and maximum, unscaled minimum and maximum, etc.); or the like. For example, in some instances, offsetting a scaled value can include adding

$$scaledMidpoint - \frac{unscaledMidpoint * ( scale Max - scale Min )}{( unscaled Max - unscaled Min )}$$

to the scaled value. As another example, in some instances, offsetting an unscaled value (e.g., before scaling the offset value) can include adding

$$\frac{scaledMidpoint * ( unscaled Max - unscaled Min )}{( scale Max - scale Min )} - unscaledMidpoint$$

to the unscaled value.

As a non-limiting illustrative example, example code or pseudocode for scaling and offsetting a value can include the following:

$$target\_min , target\_max = - 7. , 7.$$

$$value\_min = jnp . min ( x , axis = contract\_dim , keepdims = True )$$

$$value\_max = jnp . max ( x , axis = contract\_dim , keepdims = True )$$

$$scale = ( value\_max - value\_min ) / ( target\_max - target\_min )$$

$$offset = target\_min - value\_min / scale$$

$$scaled\_offset \_values = jnp . divide ( x , scale ) + offset$$

In some instances, quantization 420 can include rounding a first value based on a binary format associated with the quantization 420 (e.g., four-bit binary format, etc.). For example, in some instances, each scaled offset value can be rounded to a corresponding numerical value 104 associated with a binary representation 102 in the binary format. As a non-limiting illustrative example, if the numerical values include −7.0, −6.0, −5.0, and the like, then scaled offset values below −6.5 can be rounded to −7.0; values between −5.5 and −6.5 can be rounded to −6.0; and so on. In some instances, quantization 420 can be performed according to one or more four-bit binary formats described herein, such as a four-bit binary format described above with respect to FIGS. 1 and 2.

In some instances, quantization 420 can include representing the quantized value using a binary representation 102 corresponding to the numerical value 104 determined by the quantization 420 process (e.g., the numerical value 104 that a scaled offset value was rounded to, etc.). However, although the term “quantization” is used herein, a second value determined according to a quantization 420 process can in some instances be represented in a higher-precision binary format (e.g., format using more than four bits per number represented, etc.) without deviating from the scope of the present disclosure. For example, in some instances, quantization-aware training can include training a machine learning model 412, 416 using values (e.g., quantized weights 418) that have been scaled, rounded, or the like according to a quantization 420 process, without necessarily representing the scaled values (e.g. quantized weights 418) in a four-bit binary format during the training process.

In some instances, quantization 420 can include post-training quantization of a machine-learned model. For example, in some instances, a full-precision machine learning model 412 can include a model that has already been fully trained (e.g., pretrained, fine-tuned, etc.). In some instances, the already-trained weights 414 can be quantized to generate quantized weights 418, and the quantized machine learning model 416 comprising the quantized weights 418 can be used to perform machine-learned inference (e.g., without further training).

FIG. 5 is a block diagram of an example system for training a quantized machine learning model according to example implementations of aspects of the present disclosure. A computing system 522 can provide one or more inputs 524 to a machine learning model 512. The machine learning model 512 can generate one or more outputs 526 based on the inputs 524 using one or more transformed weights 518. Based on the outputs 526, the computing system 522 can provide one or more model updates 528 to the machine learning model 512.

In some instances, a machine learning model 512 can be, comprise, be comprised by, or otherwise share one or more properties with a full-precision or quantized machine learning model 412, 416. For example, in some instances, a machine learning model 512 can have any property described herein with respect to a full-precision or quantized machine learning model 412, 416.

In some instances, transformed weights 518 can be, comprise, be comprised by, or otherwise share one or more properties with quantized weights 418. For example, in some instances, transformed weights 518 can have any property described herein with respect to quantized weights 418. In some instances, transformed weights 518 can include weights that have been temporarily transformed (e.g., quantized) according to a quantization-aware training process or other training process (e.g., quantized training, partially quantized training, etc.). For example, in some instances, a first training iteration can include transforming weights 414 (e.g., according to a quantization 420 process) to generate transformed weights 518; determining model updates 528 based on an output determined by the machine learning model 512 using the transformed weights 518; and updating the weights 414 based on the model updates 528. In some instances, a subsequent training iteration can then include transforming the updated weights 414 to generate new transformed weights 518 before determining and applying a model update 528 based on the new transformed weights 518. However, in some instances, transformed weights 518 can include quantized weights 418 that are stored, reused, and updated during a training process (e.g., without transforming weights 414 at each training iteration) without deviating from the scope of the present disclosure.

A computing system 522 can be or include one or more software, firmware, or hardware components configured to train a machine learning model 512 (e.g., using quantization-aware, quantized, or partially quantized training) or perform one or more other activities described herein. In some instances, a computing system 522 can be, comprise, be comprised by, or share one or more properties with a computing device or system described below with respect to FIGS. 16-18 (e.g., server computing system 60, computing device 98, computing device 99, etc.).

Input(s) 524 can generally include or otherwise represent various types of data. For example, in some instances, input(s) 524 can have any property described below with respect to input(s) 2 of FIG. 10. In some instances, input(s) 524 can include one or more sequence inputs (e.g., natural language sequence inputs, etc.) configured to be input to a sequence processing model (e.g., language model, etc.). In some instances, input(s) 524 can include inputs associated with a four-bit binary format, such as binary representations 102 or numerical values 104, 204.

Output(s) 526 can generally include or otherwise represent various types of data. For example, in some instances, output(s) 526 can have any property described below with respect to output(s) 3 of FIG. 10. In some instances, output(s) 526 can include one or more sequence outputs (e.g., natural language sequence inputs; audio, video, or image generation outputs; etc.) or other outputs of a sequence processing model. In some instances, output(s) 526 can output inputs associated with a four-bit binary format, such as binary representations 102 or numerical values 104, 204. In some instances, output(s) 526 can have a data type that is the same as or different from a data type of input(s) 524.

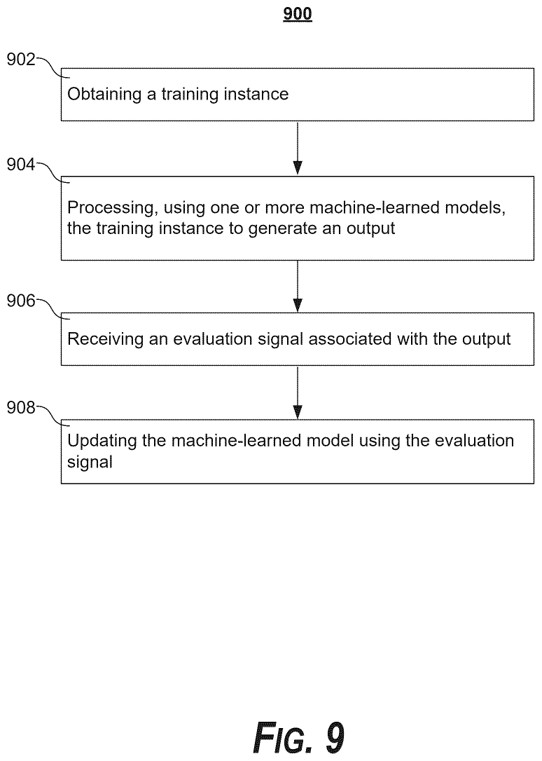

The model update(s) 528 can include updates to one or more parameters (e.g., weights 414, transformed weights 518, etc.) of the machine learning model 512. For example, the model update(s) 528 can include updating one or more parameters of the machine learning model 512 to optimize a value of an objective function (e.g., loss function, etc.). In some instances, determining a model update 528 can include performing one or more activities described below with respect to FIG. 9 (e.g., gradient-based operations, etc.).

In some instances, the model updates 528 can be determined according to a quantization-aware training, quantized training, or partially quantized training process. For example, quantization-aware training can include transforming (e.g., rounding, scaling, etc.) one or more values (e.g., machine learning model parameters, input activation values, etc.) based in part on a quantization 420 scheme; generating, based at least in part on the transformed values, an output 526; and determining a model update based on a gradient of an objective function (e.g., loss function) associated with the output. In some instances, a transformed value of a quantization-aware training process can be the same as or different from a corresponding quantized value associated with the quantization 420 scheme. For example, quantization-aware training can in some instances include rounding toward a corresponding numerical value 104 without rounding all the way to a numerical value. As another example, quantization-aware training can in some instances be performed on values that have been rounded (e.g., to a nearest value associated with a quantization 420 scheme) but not scaled or otherwise transformed (e.g., represented in a lower-precision format). Quantized and partially quantized training can include, for example, quantizing one or more values (e.g., weights 414, input activations, etc.); representing the quantized value in a lower-precision (e.g., four-bit, etc.) format; and performing a forward pass using the quantized values. Partially quantized training can further include, for example, rescaling after the forward pass and determining a model update 528 (e.g., gradient-based update) based at least in part on one or more unquantized values. Quantized training can include, for example, directly determining a model update based on one or more quantized values (e.g., quantized weights 418, output values 526 determined based on quantized weights 418, etc.).

In some instances, determining or performing a model update 528 can include adapter-based fine-tuning, such as quantization-aware adapter-based fine-tuning, quantized adapter-based fine-tuning, or partially quantized adapter-based fine-tuning. For example, a plurality of trained parameters (e.g., plurality of layers) of a pretrained machine learning model 512 can be frozen, and one or more adapter layers (e.g., layers comprising a plurality of additional untrained weights 414) can be added to the model. In some instances, one or more parameters (e.g., weights 414, transformed weights 518, etc.) of the adapter layers can be further trained in a fine-tuning process. In some instances, fine-tuning can include training the adapter layers on a specialized training dataset, such as a training dataset associated with a particular topic, problem, task, or the like. In some instances, post-training quantization can be used in combination with adapter-based fine-tuning. For example, in some instances, one or more adapter layers can be trained using a full-precision (e.g., 32-bit precision, etc.) training process, and the adapter layers can be quantized after training is complete. In some instances, quantization-aware adapter-based fine-tuning or quantized or partially quantized fine-tuning can be performed (e.g., according to methods described above, with the model updates 528 applied to one or more adapter layers).

FIG. 6 is a block diagram of an example computing system for performing operations using a four-bit binary data format according to example implementations of aspects of the present disclosure. One or more registers 630 can obtain one or more binary representations 102. Based on the binary representations 102, the registers 630 can output one or more corresponding numerical values 604. In some instances, the numerical values 604 can be provided to one or more multipliers 632, which can generate one or more multiplication outputs 634 based on the numerical values 604.

In some instances, a numerical value 604 can be, comprise, be comprised by, or otherwise share one or more properties with a numerical value 104. For example, in some instances, a numerical value 604 can have any property described with respect to a numerical value 104.

In some instances, a numerical value 604 can include a raw numerical value 104, 204 associated with a four-bit binary representation, or can include a rescaled value associated with a corresponding numerical value 104, 204. For example, in some instances, a numerical value 604 may include a higher-precision (e.g., six-bit, 32-bit, etc.) representation of a numerical value 104 (e.g., one of the values {−28, −24, −20, −16, −12, −8, −4, −1, 1, 4, 8, 12, 16, 20, 24, 28}, etc.). In other instances, a numerical value 604 may include a rescaled value determined according to an inverse quantization 420 process based on a numerical value 104. As an example, if quantizing a full-precision parameter value includes multiplying the parameter value by a scaling parameter; then adding an offset value to the scaled value; then rounding to the nearest numerical value 104, then an inverse quantization 420 process can include subtracting the offset value from the numerical value 104; then dividing the parameter value by the scaling factor. In some instances, a plurality of rescaled values (e.g., sixteen rescaled values, 16n rescaled values where n is a number of channelwise scales, etc.) can be precomputed and stored in one or more register(s) 630 to be retrieved based on an input binary representation 102.

A register 630 can include, for example, a fast storage device configured to store one or more numerical values 604. In some instances, each register 630 can store one numerical value 604 or multiple numerical values 604. In some instances, the numerical values 604 can be retrieved from the registers 630 based on a corresponding binary representation 102 or data indicative of a binary representation 102. In some instances, one or more other hardware devices may be used to generate numerical values 604 (e.g., instead of or in addition to registers 630), such as multiplexers, field programmable gate arrays, other programmable logic devices, or other hardware devices. For example, in some instances, a multiplexer or other programmable logic device can be used to select between one or more registers 630 or between one or more numerical values 604 stored in the registers 630 (e.g., based on a selection signal indicative of a binary representation 102). In some instances, selecting between numerical values 604 can be based at least in part on data (e.g., selection signal, etc.) indicative of a scale (e.g., channel-wise scale, etc.) associated with one or more rescaled numerical values 604.

A multiplier 632 can include, for example, a circuit configured to perform multiplication in one or more binary formats (e.g., floating-point format, integer format, fixed-point decimal format, etc.). Example multipliers can include shift-and-add multipliers, single cycle multipliers, Wallace tree multipliers, Dadda multipliers, and the like. Although FIG. 6 depicts one or more multipliers 632, other arithmetic hardware (e.g., adders, arithmetic logic units, etc.) can be used (e.g., instead of or in addition to multipliers 632) without deviating from the scope of the present disclosure.

Multiplication outputs 634 can include, for example, a numerical value in any format, such as a numerical value 104, 204, 604; a numerical value in a higher-precision format (e.g., 8-bit, 16-bit, 32-bit, etc.); or other numerical value. In some instances, multiplication outputs 634 can include a result of a multiplication between a first numerical value 104, 204 associated with a four-bit binary data format and a second numerical value 104, 204 associated with a four-bit binary data format; a numerical value 104, 204 associated with a four-bit binary data format and a higher-precision numerical value; or other multiplication involving a numerical value 604. In some instances, a multiplication 634 can include a result of a multiplication of a parameter (e.g., weight 414, 418, 518, etc.) of one or more machine learning models 412, 416, 512 and another value (e.g., input activation, etc.). In some instances, one or more of a parameter and an activation can be represented in one or more four-bit binary formats described herein (e.g., with respect to FIGS. 1 and 2). In some instances, one or more of a parameter and an activation can be represented in one or more other formats, such as lower-precision (e.g., two-bit, one-bit, etc.) or higher-precision (e.g., eight-bit, sixteen-bit, 32-bit, etc.) formats.

In some instances, the multiplication outputs 634 can be provided to one or more other hardware devices (e.g., adders, etc.) to perform additional operations. In some instances, additional operations performed on multiplication outputs 634 can include one or more machine learning operations. For example, in some instances, a multiplication output 634 can be a component of a matrix multiplication (e.g., multiplication of parameter values and activation values associated with a machine learning model layer, etc.). In some instances, a matrix multiplication can be a component of a machine learning inference forward pass. In some instances, one or more results of one or more matrix multiplications can be used to generate one or more machine learning outputs (e.g., natural language text or audio sequence, image generation output, video generation output, etc.).

### Example Methods

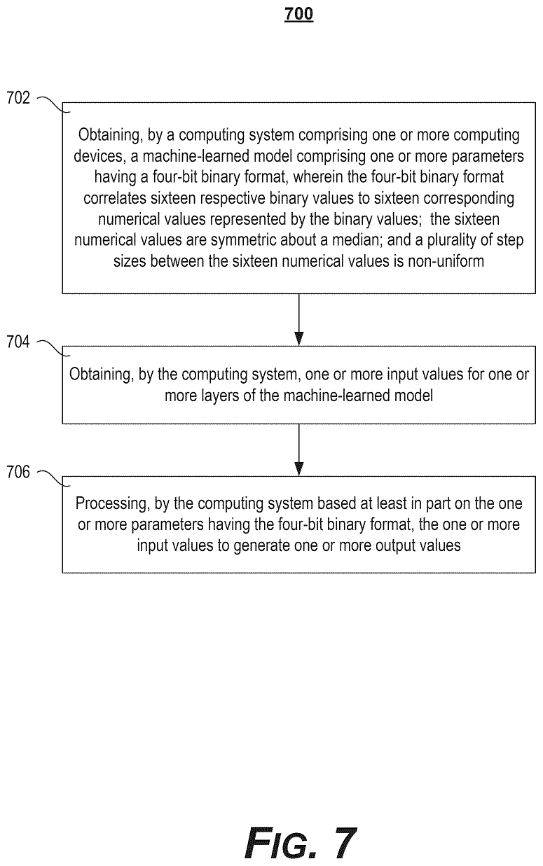

FIG. 7 depicts a flowchart diagram of an example method for performing machine-learned inference using example four-bit binary formats according to example embodiments of the present disclosure. Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include obtaining, by a computing system comprising one or more computing devices, a machine-learned model (e.g., machine-learned model 316, 512, quantized machine-learned model 416, etc.) comprising one or more parameters (e.g., parameters 308, etc.) having a four-bit binary format, wherein the four-bit binary format correlates sixteen respective binary values (e.g., binary representations 102) to sixteen corresponding numerical values (e.g., numerical values 104, 204, 604) represented by the binary values; the sixteen numerical values are symmetric about a median; and a plurality of step sizes between the sixteen numerical values is non-uniform. In some instances, example method 700 at 702 can include using one or more systems or performing one or more activities described with respect to FIG. 3.

At 704, example method 700 can include obtaining, by the computing system, one or more input values (e.g., inputs 306, 524, etc.) for one or more layers of the machine-learned model. In some instances, example method 700 at 704 can include using one or more systems or performing one or more activities described with respect to FIG. 3.

At 706, example method 700 can include processing, by the computing system based at least in part on the one or more parameters having the four-bit binary format, the one or more input values to generate one or more output values (e.g., output values 310, 526, etc.). In some instances, example method 700 at 706 can include using one or more systems or performing one or more activities described with respect to FIG. 3.

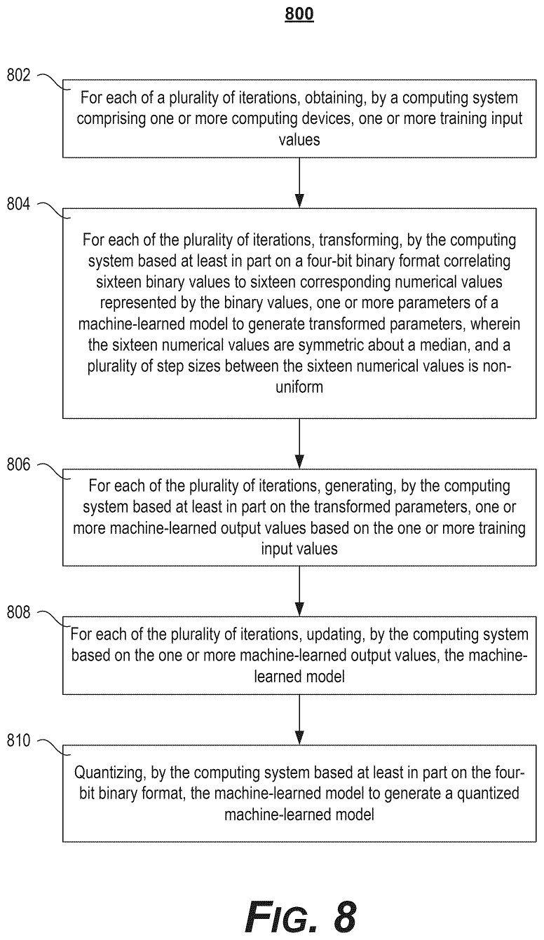

FIG. 8 depicts a flowchart diagram of an example method for training a quantized machine-learned model using quantization-aware training according to example embodiments of the present disclosure. Although FIG. 8 depicts steps performed in a particular order for purposes of illustration and discussion, the methods of the present disclosure are not limited to the particularly illustrated order or arrangement. The various steps of example method 800 can be omitted, rearranged, combined, and/or adapted in various ways without deviating from the scope of the present disclosure.

At 802, example method 800 can include, for each of a plurality of iterations, obtaining, by a computing system comprising one or more computing devices, one or more training input values (e.g., inputs 524, etc.). In some instances, example method 800 at 802 can include using one or more systems or performing one or more activities described with respect to FIG. 5.

At 804, example method 800 can include, for each of the plurality of iterations, transforming, by the computing system based at least in part on a four-bit binary format correlating sixteen binary values to sixteen corresponding numerical values represented by the binary values, one or more parameters (e.g., weights 414, etc.) of a machine-learned model (e.g., machine-learned model 512) to generate transformed parameters (e.g., transformed weights 518), wherein the sixteen numerical values are symmetric about a median and a plurality of step sizes between the sixteen numerical values is non-uniform. In some instances, example method 800 at 804 can include using one or more systems or performing one or more activities described with respect to FIG. 5.

At 806, example method 800 can include, for each of the plurality of iterations, generating, by the computing system based at least in part on the transformed parameters, one or more machine-learned output values (e.g., outputs 526) based on the one or more training input values. In some instances, example method 800 at 806 can include using one or more systems or performing one or more activities described with respect to FIG. 5.

At 808, example method 800 can include, for each of the plurality of iterations, updating (e.g., according to one or more model updates 528), by the computing system based on the one or more machine-learned output values, the machine-learned model. In some instances, example method 800 at 808 can include using one or more systems or performing one or more activities described with respect to FIG. 5.

At 810, example method 800 can include quantizing, by the computing system based at least in part on the four-bit binary format, the machine-learned model to generate a quantized machine-learned model (e.g., quantized machine-learned model 416). In some instances, example method 800 at 810 can include using one or more systems or performing one or more activities described with respect to FIG. 4.

FIG. 9 depicts a flowchart of a method 900 for training one or more machine-learned models according to aspects of the present disclosure. For instance, an example machine-learned model can include a full-precision machine learning model 412, quantized machine learning model 416, or machine learning model 512.

One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

At 902, example method 900 can include obtaining a training instance. A set of training data can include a plurality of training instances divided between multiple datasets (e.g., a training dataset, a validation dataset, or testing dataset). A training instance can be labeled or unlabeled. Although referred to in example method 900 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 904, example method 900 can include processing, using one or more machine-learned models, the training instance to generate an output. The output can be directly obtained from the one or more machine-learned models or can be a downstream result of a chain of processing operations that includes an output of the one or more machine-learned models.

At 906, example method 900 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 908, example method 900 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 900 can include implementing a number of generalization techniques (e.g., weight decays, dropouts, etc.) to improve the generalization capability of the models being trained.

In some implementations, example method 900 can be implemented for training a machine-learned model from an initialized state to a fully trained state (e.g., when the model exhibits a desired performance profile, such as based on accuracy, precision, recall, etc.).

In some implementations, example method 900 can be implemented for particular stages of a training procedure. For instance, in some implementations, example method 900 can be implemented for pre-training a machine-learned model. Pre-training can include, for instance, large-scale training over potentially noisy data to achieve a broad base of performance levels across a variety of tasks/data types. In some implementations, example method 900 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

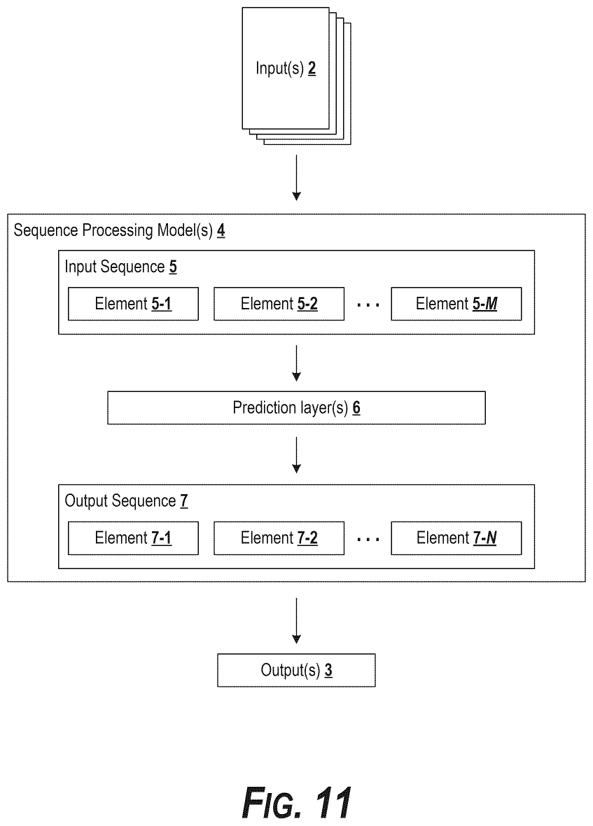

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

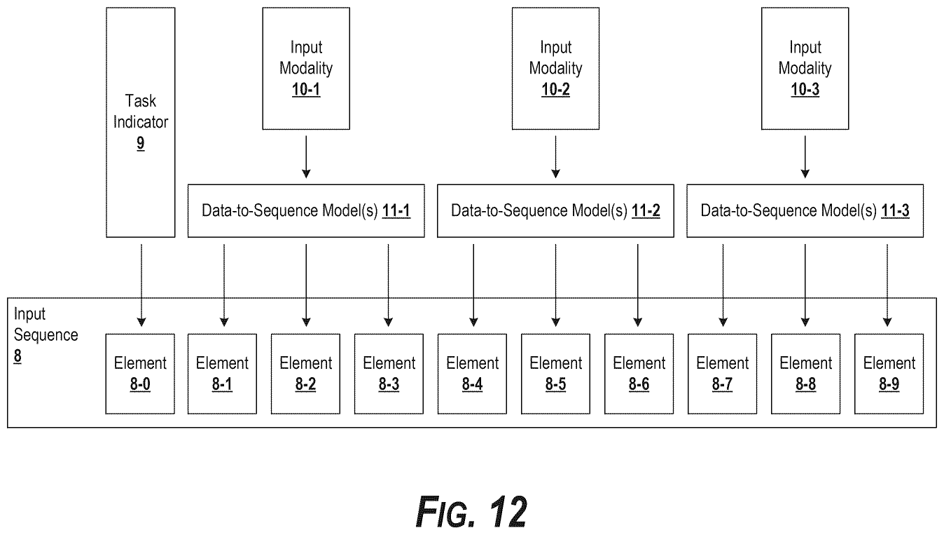

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

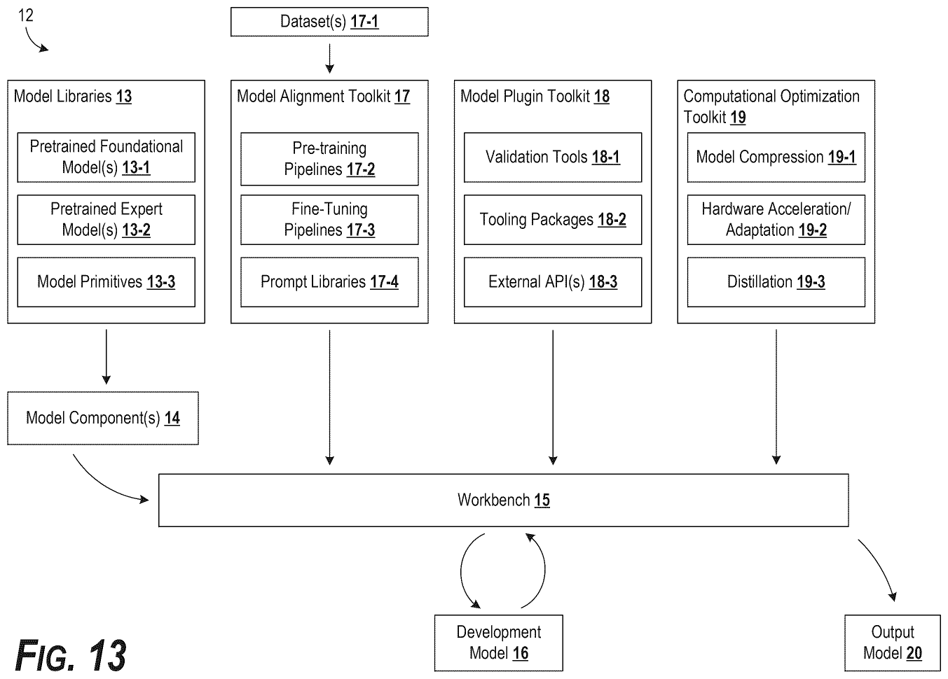

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

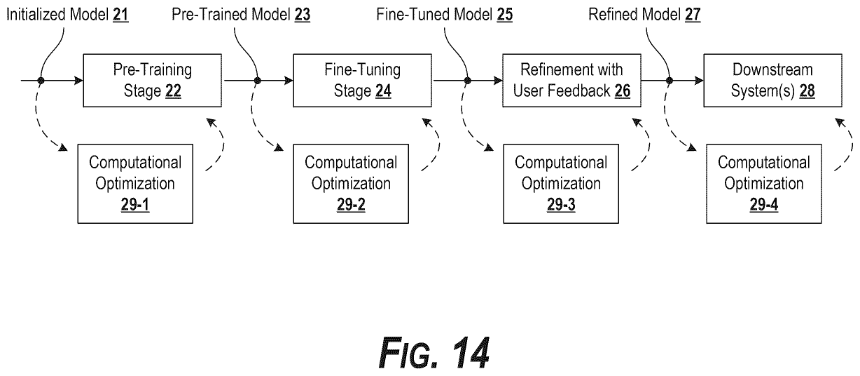

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

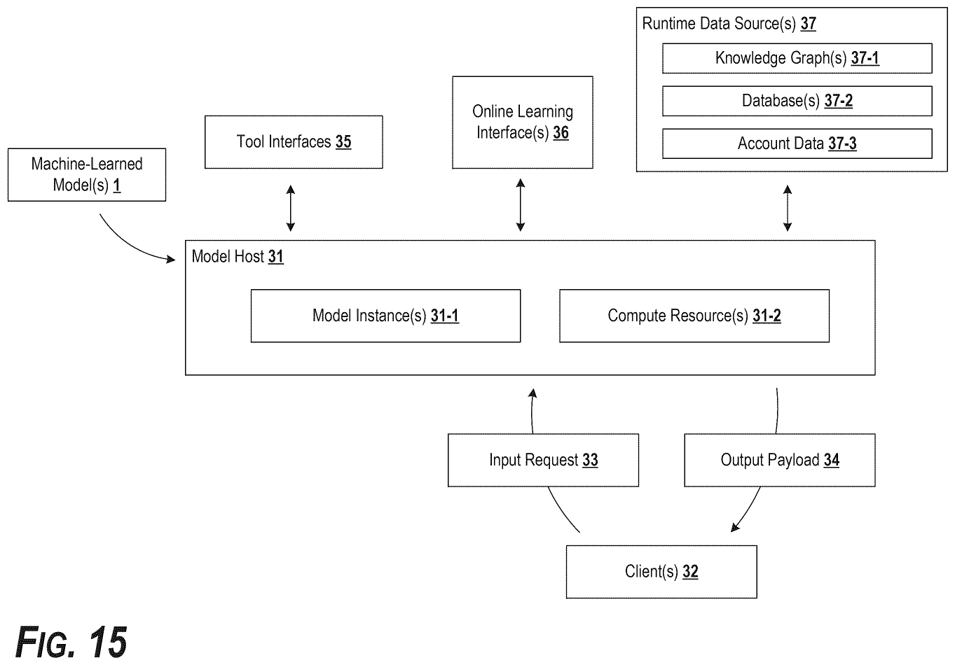

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) I can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 16 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 16 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

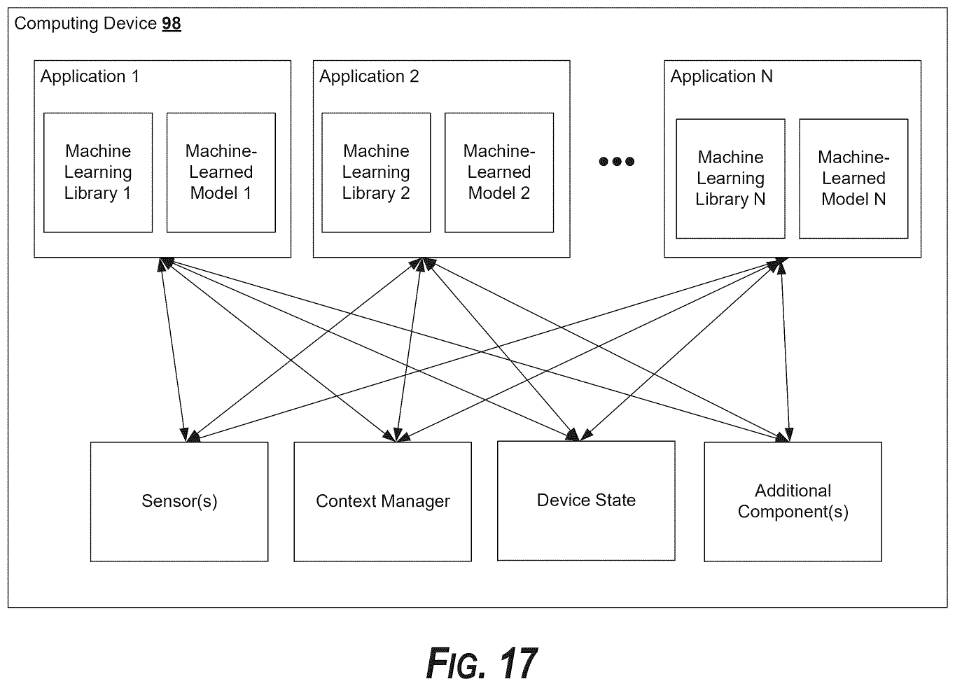

FIG. 17 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

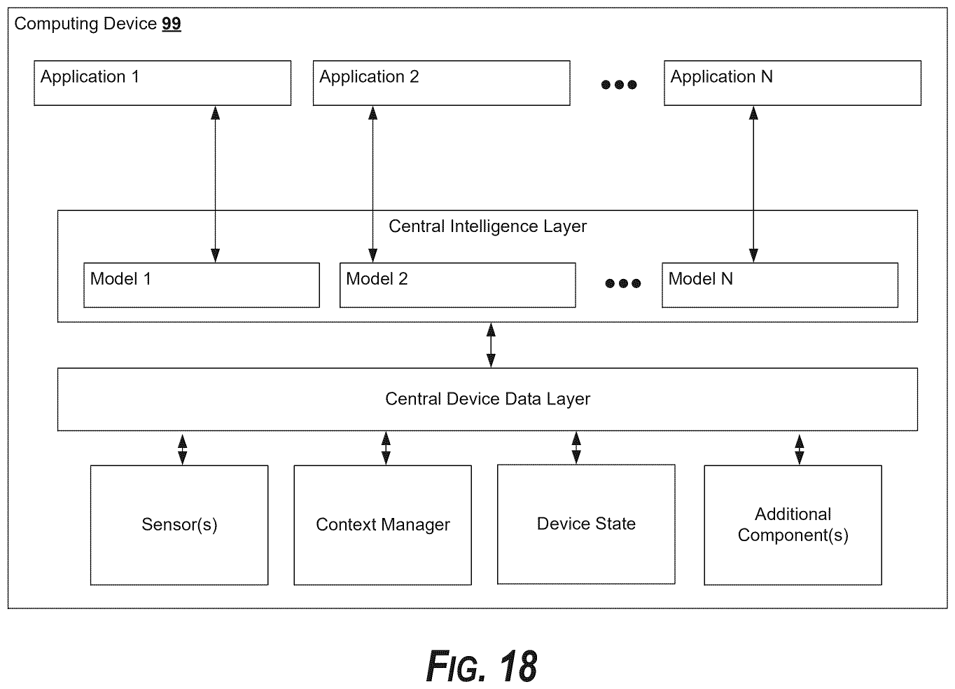

FIG. 18 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 18, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 18, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method comprising:
obtaining, by a computing system comprising one or more computing devices, a machine-learned model comprising one or more parameters having a four-bit binary format, wherein:
the four-bit binary format correlates sixteen respective binary values to sixteen corresponding numerical values represented by the binary values;
the sixteen numerical values are symmetric about a median; and
a plurality of step sizes between the sixteen numerical values is non-uniform;
obtaining, by the computing system, one or more input values for one or more layers of the machine-learned model; and
processing, by the computing system based at least in part on the one or more parameters having the four-bit binary format, the one or more input values to generate one or more output values.

2. The method of claim 1, wherein a difference between a first value and second value of the sixteen numerical values is larger than a difference between a third value and a fourth value of the sixteen numerical values, wherein each of the third and fourth values is closer to the median than each of the first and second values.

3. The method of claim 1, wherein the sixteen numerical values consist of: [−7, −6, −5, −4, −3, −2, −1, −0.25, 0.25, 1, 2, 3, 4, 5, 6, 7].

4. The method of claim 1, wherein at least one of the one or more input values has the four-bit binary format.

5. The method of claim 1, wherein at least one of the one or more output values has the four-bit binary format.

6. The method of claim 1, wherein the machine-learned model is a first machine-learned model, and obtaining the first machine-learned model comprises:
obtaining a second machine-learned model having one or more parameters having a binary format requiring more than four bits to represent each numerical value; and
quantizing the one or more parameters of the second machine-learned model to determine the one or more parameters of the first machine-learned model.

7. The method of claim 6, wherein the second machine-learned model was trained by:
for each of a plurality of iterations:
obtaining, by the computing system, one or more training input values;
transforming, by the computing system based at least in part on the sixteen numerical values, the one or more parameters of the second machine-learned model to generate transformed parameters;
generating, by the computing system based at least in part on the transformed parameters, one or more machine-learned output values based on the one or more training input values; and
updating, by the computing system based on the one or more machine-learned output values, the second machine-learned model.

8. The method of claim 7, wherein the second machine-learned model comprises one or more adapter layers, and updating the second machine-learned model comprises updating the one or more adapter layers.

9. The method of claim 1, further comprising training the machine-learned model by:
for each of a plurality of iterations:
obtaining, by the computing system, one or more training input values;
generating, by the computing system based at least in part on the one or more parameters having the four-bit binary format, one or more machine-learned output values based on the training input values; and
updating, by the computing system based at least in part on the one or more output values, the machine-learned model.

10. The method of claim 9, wherein the machine-learned model comprises one or more adapter layers, and updating the machine-learned model comprises updating the one or more adapter layers.

11. The method of claim 1, wherein a ratio of each step size of the sixteen numerical values to a difference between a highest value and lowest value of the sixteen numerical values is within 30 percent of:
$$[ \frac{1}{14} , \frac{1}{14} , \frac{1}{14} , \frac{1}{14} , \frac{1}{14} , \frac{1}{14} , \frac{3}{56} , \frac{2}{56} , \frac{3}{56} , \frac{1}{14} , \frac{1}{14} , \frac{1}{14} , \frac{1}{14} , \frac{1}{14} , \frac{1}{14} ] .$$

12. The method of claim 1, wherein generating the one or more output values comprises:
mapping, by the computing system based on the binary format, the one or more parameters to one or more corresponding numerical parameter values; and
performing, by the computing system using the numerical parameter values, a forward pass of the machine-learned model.

13. The method of claim 12, wherein the mapping comprises:
scaling, by the computing system based on a first scaling factor associated with a first channel of a tensor comprising a plurality of parameters of the machine-learned model, a first plurality of numerical parameter values associated with the first channel; and
scaling, by the computing system based on a second scaling factor associated with a second channel of the tensor, a second plurality of numerical parameter values associated with the second channel.

14. The method of claim 13, wherein the mapping further comprises:
offsetting, by the computing system based on a first offset value associated with the first channel, the first plurality of numerical parameter values; and
offsetting, by the computing system based on a second offset value associated with the second channel, the second plurality of numerical parameter values.

15. The method of claim 12, wherein the one or more corresponding numerical parameter values are represented in a binary format having more than four bits.

16. The method of claim 12, wherein the mapping comprises:
retrieving, from one or more registers based at least in part on the one or more input values having the four-bit binary format, the one or more numerical parameter values.

17. The method of claim 1, wherein a difference between an eighth highest value and ninth highest value of the sixteen numerical values is within 10 percent of 2/56 of a difference between a highest value and lowest value of the sixteen numerical values.

18. The method of claim 1, wherein:
a difference between a seventh highest value and an eighth highest value of the sixteen numerical values is within 10 percent of 3/56 of a difference between a highest value and lowest value of the sixteen numerical values; and
a difference between a ninth highest value and a tenth highest value of the sixteen numerical values is within 10 percent of 3/56 of a difference between a highest value and lowest value of the sixteen numerical values.

19. The method of claim 1, wherein none of the sixteen numerical values are equal to zero.

20. A computing system comprising one or more processors and one or more non-transitory computer-readable media storing instructions that are executable by one or more processors to cause the computing system to perform operations, the operations comprising:
obtaining a machine-learned model comprising one or more parameters having a four-bit binary format, wherein:
the four-bit binary format correlates sixteen respective binary values to sixteen corresponding numerical values represented by the binary values;
the sixteen numerical values are symmetric about a median; and
a plurality of step sizes between the sixteen numerical values is non-uniform;
obtaining one or more input values for one or more layers of the machine-learned model; and
processing, based at least in part on the one or more parameters having the four-bit binary format, the one or more input values to generate one or more output values.

21. The computing system of claim 20, further comprising one or more registers storing one or more numerical values of the sixteen numerical values, wherein the operations further comprise retrieving, from the one or more registers based on a first binary representation of the sixteen respective binary values, a corresponding first numerical value of the sixteen numerical values.

22. The computing system of claim 21, further comprising one or more multipliers configured to generate, based on the first numerical value and a second numerical value, a multiplication output.

23. The computing system of claim 20, further comprising one or more matrix multiplication units configured to perform matrix multiplications based on input values associated with the four-bit binary format.

24. One or more non-transitory computer-readable media storing instructions that are executable by one or more processors to cause a computing system to perform operations, the operations comprising:
obtaining a machine-learned model comprising one or more parameters having a four-bit binary format, wherein:
the four-bit binary format correlates sixteen respective binary values to sixteen corresponding numerical values represented by the binary values;
the sixteen numerical values are symmetric about a median; and
a plurality of step sizes between the sixteen numerical values is non-uniform;
obtaining one or more input values for one or more layers of the machine-learned model; and
processing, based at least in part on the one or more parameters having the four-bit binary format, the one or more input values to generate one or more output values.

25. A processor device comprising:
one or more registers storing one or more numerical values associated with a four-bit binary format, wherein:
the four-bit binary format correlates sixteen respective binary values to sixteen corresponding numerical values represented by the binary values;
the sixteen numerical values are symmetric about a median; and
a plurality of step sizes between the sixteen numerical values is non-uniform;
one or more programmable logic devices configured to retrieve, from the one or more registers based on a first binary value of the sixteen respective binary values, a corresponding first numerical value of the sixteen corresponding numerical values; and
arithmetic hardware configured to perform operations based at least in part on the first numerical value.

26. The processor device of claim 25, wherein the arithmetic hardware comprises one or more multipliers.
